(19) United States
(12) Patent Application Publication
(10) Pub. No.: US 2026/0362473 A1
(43) Pub. Date: Nov. 12, 2026

(54) DATA TRANSMISSION OF STATION IN WIRELESS LAN SYSTEM

(71) Applicant: LG Electronics Inc., Seoul (KR)

(72) Inventors: Jinyoung CHUN, Seoul (KR); Jinsoo CHOI, Seoul (KR); Dongguk LIM, Seoul (KR); Eunsung PARK, Seoul (KR); Insun JANG, Seoul (KR)

(21) Appl. No.: 19/515,091

(22) PCT Filed: May 7, 2024
(86) PCT No.: PCT/KR2024/006083

§ 371 Date: Feb. 27, 2026

(30) Foreign Application Priority Data
Aug. 30, 2023 (KR) 10-2023-0114838

(51) Int. Cl. H04W 74/00; H04W 74/0816; H04W 84/12

(52) U.S. Cl. CPC H04W 74/002; H04W 74/0816; H04W 84/12

(57) ABSTRACT

The technical features of the present disclosure can relate to a method performed in a wireless local area network (WLAN) system. One embodiment of the present disclosure can relate to a method performed in a WLAN system. According to the described method, a station (STA) can set a network allocation vector (NAV) on the basis of an intra basic service set (BSS) physical protocol data unit (PPDU). For example: the STA can determine whether to consider the NAV on the basis of a packet to be transmitted by the STA and whether the STA is either a transmission opportunity (TXOP) holder or a TXOP responder; and, if the STA is neither the TXOP holder nor the TXOP responder and the packet to be transmitted is related to a low latency packet, the STA may not consider the NAV.

### TECHNICAL FIELD

The present specification is related to a wireless local area network (WLAN) system, and more specifically, is related to a method and apparatus for a station (STA) of the wireless local area network system to transmit data within a transmission opportunity (TXOP).

### BACKGROUND ART

Wireless Local Area Network or WLAN (wireless local area network) has been improved in various ways. For example, Extreme High Throughput (EHT) specification can use a newly proposed increased bandwidth, an improved PHY layer protocol data unit (PPDU) structure, an improved sequence, Hybrid Automatic Repeat Request (HARQ) technique, and the like. The EHT specification may be referred to as IEEE 802.11 be specification.

In the EHT specification, in order to support high throughput and a high data rate, wide bandwidth (e.g., 160/320 MHz), 16 streams, and/or multi-link (or multi-band) operation, and the like can be used.

In the EHT specification, wide bandwidth (e.g., 160/240/320 MHz) can be used for high throughput. Also, in order to efficiently use bandwidth, preamble puncturing and multiple RU transmission can be used.

The WLAN system can be further improved through Ultra High Reliability (UHR) specification. The UHR system may be referred to as IEEE 802.11bn specification. The UHR system aims to support ultra-high reliability during signal transmission to a STA. For this, in the UHR system, various techniques for supporting high throughput, low latency, extended range, and the like are considered.

In the WLAN system, communication can be initiated in a station (STA) having acquired a transmission opportunity (TXOP). That is, in the conventional WLAN system, until the TXOP ends, a TXOP holder/responder defined in the conventional standard can transmit data, and data transmission of another STA is restricted.

### SPECIFICATION

### Technical Problem

In a conventional WLAN system, until a transmission opportunity (TXOP) ends, a TXOP holder/responder defined in a conventional standard can transmit data, and data transmission of other STAs is restricted. However, a case may occur where data/packet/signal must be transmitted rapidly before the corresponding TXOP ends. Even in such a case, when conventional technical features related to the TXOP are used, a problem of increasing data latency may occur.

The present specification improves operations related to a conventional TXOP and/or a network allocation vector (NAV). Through this, it is possible to solve a technical problem of not being able to transmit low-latency data during a conventionally set TXOP.

### Technical Solution

The present specification proposes various technical features. Various technical features of the present specification may be related to a specific STA, a processor, instructions, and the like.

For example, the technical feature of the present specification may be related to a method performed in a specific STA. For example, an example of the present specification may be related to a method performed in a Wireless Local Area Network (WLAN) system. Based on the above-described method, a STA may set a network allocation vector (NAV) based on an intra basic service set (BSS) Physical Protocol Data Unit (PPDU). For example, based on whether the STA is any one of a transmission opportunity (TXOP) holder and a TXOP responder and based on a packet to be transmitted by the STA, the STA may determine whether to consider the NAV. For example, when the STA is not the TXOP holder and is not the TXOP responder and a packet to be transmitted is related to a low latency packet, the STA may not consider the NAV.

### Advantageous Effects

The technical features described in the present specification may generate various advantageous effects. Based on a conventional WLAN specification, after a TXOP is acquired, the TXOP holder/responder can transmit data within the TXOP, and data transmission of another STA is restricted. However, a case may occur in which data/packet/signal must be transmitted rapidly before the corresponding TXOP ends. Even in such a case, a problem in which latency of data increases may occur when the conventional technical features related to the TXOP are used.

The present specification improves operations related to a conventional TXOP and/or NAV. Through this, it is possible to solve a technical problem in which data satisfying a specific requirement cannot be transmitted during a conventionally set TXOP. For example, when it becomes possible to transmit data even during the TXOP through the present specification, it is possible to prevent an unnecessary delay from occurring in the transmission of data with low latency.

### BRIEF DESCRIPTION OF THE DRAWINGS

FIG. I shows an example of a transmitting device and/or a receiving device of the present specification.

FIG. 2 is a conceptual diagram showing a structure of a Wireless Local Area Network (WLAN).

FIG. 3 is a diagram explaining a general link setup process.

FIG. 4 explains an embodiment of a Multi-link (ML).

FIG. 5 explains a PPDU transmitted/received in a STA of the present specification.

FIG. 6 is a diagram showing an arrangement of a resource unit (RU) used for a 20 MHz PPDU.

FIG. 7 is a diagram showing an arrangement of a resource unit (RU) used for a 40 MHZ PPDU.

FIG. 8 is a diagram showing an arrangement of a resource unit (RU) used for an 80 MHz PPDU.

FIG. 9 shows an operation based on UL-MU.

FIG. 10 shows an example of a channel used/supported/defined within a 2.4 GHz band.

FIG. 11 shows an example of a channel used/supported/defined within a 5 GHz band.

FIG. 12 shows an example of a channel used/supported/defined within a 6 GHz band.

FIG. 13 shows an example of a header of a MAC frame.

FIG. 14 shows a modified example of a transmitting device and/or a receiving device of the present specification.

FIG. 15 is related to an operation performed in a device proposed in the present specification.

FIG. 16 is related to another operation performed in a device proposed in the present specification.

FIG. 17 is an example of a procedure flowchart of the present specification.

### DESCRIPTION OF EXEMPLARY EMBODIMENTS

As used herein, “A or B” can mean “only A,” “only B,” or “both A and B.” Alternatively, “A or B” can be interpreted as “A and/or B.” For example, as used herein, “A, B or C” can mean “only A,” “only B,” “only C,” or “any combination of A, B, and C.”

As used herein, a slash (/) or a comma can mean “and/or.” For example, “A/B” can mean “A and/or B.” Accordingly, “A/B” can mean “only A,” “only B,” or “both A and B.” For example, “A, B, C” may mean “A, B, or C.”

In the present specification, “at least one of A and B” may mean “only A,” “only B,” or “both A and B.” Furthermore, in the present specification, the expressions “at least one of A or B” or “at least one of A and/or B” may be interpreted identically to “at least one of A and B.” Furthermore, parentheses used herein may mean “for example.” Specifically, when

“control information (UHR-Signal field)” is indicated, the “UHR-Signal field” may be suggested as an example of “control information.” In other words, the “control information” in the present specification is not limited to the “UHR-Signal field,” and the “UHR-Signal field” may be proposed as an example of “control information.” Furthermore, even when “control information (UHR-Signal field)” is indicated, the “UHR-Signal field” may be proposed as an example of “control information.”

Furthermore, “a/an” as used herein may mean “at least one” or “one or more.” Furthermore, terms ending in “(s)” may mean “at least one” or “one or more.”

Furthermore, the expressions “based on,” “on the basis of,” or “according to” used in the present specification mean “based at least in part on,” and do not mean “based solely on” a single element one.

Technical features individually described in a single drawing in the present specification may be implemented individually or simultaneously.

The following examples of the present specification may be applied to various wireless communication systems. For example, the following examples of the present specification may be applied to wireless local area network (WLAN) systems. For example, the present specification may be applied to the IEEE 802.11a/g/n/ac/ax/be/bn standards. Furthermore, the examples of the present specification may also be applied to the Ultra High Reliability (UHR) standard or next-generation WLAN standards that enhance IEEE 802.11bn. Additionally, examples of the present specification may be applied to mobile communication systems. For example, it may be applied to mobile communication systems based on Long Term Evolution (LTE) and its evolutions based on the 3rd Generation Partnership Project (3GPP) standards.

Hereinafter, to explain the technical features of the present specification, technical features to which the present specification can be applied will be described.

FIG. 1 illustrates an example of a transmitting device and/or receiving device of the present specification.

The example of FIG. 1 can perform various technical features described below. FIG. 1 relates to at least one STA (station). For example, the STAs (110, 120) of the present specification may also be referred to by various names, such as a mobile terminal, a wireless device, a wireless transmit/receive unit (WTRU), a user equipment (UE), a mobile station (MS), a mobile subscriber unit (MS), or simply a user. The STAs (110, 120) of the present specification may also be referred to by various names, such as a network, a base station, a Node-B, an access point (AP), a repeater, a router, or a relay. The STAs (110, 120) of the present specification may be referred to by various names, such as a receiving apparatus, a transmitting apparatus, a receiving STA, a transmitting STA, a receiving device, or a transmitting device.

For example, the STAs (110, 120) of the present specification may function as an access point (AP) or a non-AP. That is, the STAs (110, 120) of the present specification may perform the functions of an AP and/or a non-AP STA. In the present specification, an AP may also be referred to as an AP STA.

The STAs (110, 120) of the present specification may support various communication standards other than the IEEE 802.11 standard. For example, they may support communication standards based on the 3GPP standard (e.g., LTE, LTE-A, 5G NR standards). Furthermore, the STAs of the present specification may be implemented in various devices, such as mobile phones, vehicles, and personal computers. Additionally, the STA of the present specification can support communication for various communication services, such as voice calls, video calls, data communications, and autonomous driving (self-driving).

In the present specification, the STAs (110, 120) may include a medium access control (MAC) and a physical layer interface for wireless media that conforms to the IEEE 802.11 standard.

The STAs (110, 120) are described below based on sub-drawing (a) of FIG. 1.

The first STA (110) may include a processor (111), memory (112), and a transceiver (113). The illustrated processor, memory, and transceiver may be implemented as separate chips, or at least two blocks/functions may be implemented on a single chip.

The transceiver (113) of the first STA performs signal transmission and reception operations. Specifically, it can transmit and receive IEEE 802.11 packets (e.g., IEEE 802.11a/b/g/n/ac/ax/be, etc.).

For example, the first STA (110) can perform the intended operation of an AP. For example, the processor (111) of the AP can receive a signal via the transceiver (113), process the received signal, generate a transmission signal, and perform control for signal transmission. The memory (112) of the AP can store a signal received via the transceiver (113) (e.g., a received signal) and a signal to be transmitted via the transceiver (e.g., a transmitted signal).

For example, the second STA (120) can perform the intended operation of a non-AP STA. For example, the transceiver (123) of the non-AP can perform signal transmission and reception operations. Specifically, it can transmit and receive IEEE 802.11 packets (e.g., IEEE 802.11a/b/g/n/ac/ax/be, etc.).

For example, the processor (121) of the non-AP STA can receive signals via the transceiver (123), process the received signals, generate transmission signals, and perform control for signal transmission. The memory (122) of the non-AP STA can store signals received via the transceiver (123) (e.g., received signals) and signals to be transmitted via the transceiver (e.g., transmitted signals).

For example, the operations of a device designated as an AP in the following specification can be performed by the first STA (110) or the second STA (120). For example, if the first STA (110) is an AP, the operation of the device indicated as the AP is controlled by the processor (111) of the first STA (110), and a related signal may be transmitted or received through the transceiver (113) controlled by the processor (111) of the first STA (110). In addition, control information related to the operation of the AP or the transmission/reception signal of the AP may be stored in the memory (112) of the first STA (110). In addition, if the second STA (110) is an AP, the operation of the device indicated as the AP is controlled by the processor (121) of the second STA (120), and a related signal may be transmitted or received through the transceiver (123) controlled by the processor (121) of the second STA (120). In addition, control information related to the operation of the AP or the transmission/reception signals of the AP may be stored in the memory (122) of the second STA (110).

For example, the operation of a device indicated as a non-AP (or User-STA) in the following specification may be performed in the first STA (110) or the second STA (120). For example, if the second STA (120) is a non-AP, the operation of the device indicated as a non-AP may be controlled by the processor (121) of the second STA (120), and related signals may be transmitted or received through the transceiver (123) controlled by the processor (121) of the second STA (120). In addition, control information related to the operation of the non-AP or the transmission/reception signals of the AP may be stored in the memory (122) of the second STA (120). For example, if the first STA (110) is a non-AP, the operation of a device designated as a non-AP is controlled by the processor (111) of the first STA (110), and related signals may be transmitted or received through a transceiver (113) controlled by the processor (111) of the first STA (120). Furthermore, control information related to the operation of the non-AP or the transmission/reception signals of the AP may be stored in the memory (112) of the first STA (110).

In the following specifications, (transmitting/receiving) STA, first STA, second STA, STA1, STA2, AP, first AP, second AP, AP1, AP2, (transmitting/receiving) Terminal, (transmitting/receiving) device, (transmitting/receiving) apparatus, network, etc., may refer to the STA (110, 120) in FIG. 1. For example, devices indicated without specific drawing symbols as (transmitting/receiving) STA, First STA, Second STA, STA1, STA2, AP, First AP, Second AP, AP1, AP2, (transmit/receive) terminal, (transmit/receive) device, (transmit/receive) apparatus, network, etc., may also refer to the STA (110, 120) in FIG. 1. For example, in the following example, the operation of various STAs transmitting and receiving signals (e.g., PPDU) may be performed by the transceivers (113, 123) in FIG. 1. Additionally, in the following example, the actions of various STAs generating transmission/reception signals or performing data processing or calculations in advance for transmission/reception signals may be performed by the processor (111, 121) in FIG. 1. For example, an example of the operation of generating transmission/reception signals or performing data processing or calculations in advance for transmission/reception signals is: 1) determining/obtaining/configuring/calculating/decoding/encoding the bit information of the subfields (SIG, STF, LTF, Data) included in the PPDU; 2) determining/configuring/acquiring time resources or frequency resources (e.g., subcarrier resources) used for the subfields (SIG, STF, LTF, Data) included in the PPDU; 3) determining/configuring/acquiring specific sequences (e.g., pilot sequences, STF/LTF sequences, extra sequences applied to SIG) used for the subfields (SIG, STF, LTF, Data) included in the PPDU; 4) power control actions and/or power saving actions applied to STA, 5) actions related to determining/obtaining/configuring/calculating/decoding/encoding ACK signals. Additionally, in the following example, various information (e.g., information related to fields/subfields/control fields/parameters/power, etc.) used by various STAs for determining/acquiring/configuring/calculating/decoding/encoding transmission/reception signals may be stored in the memory (112, 122) shown in FIG. 1.

The device/STA of sub-drawing (a) of FIG. 1 described above can be modified as shown in sub-drawing (b) of FIG. 1. The STAs (110, 120) of the present specification will now be described based on sub-drawing (b) of FIG. 1.

For example, the transceivers (113, 123) illustrated in sub-drawing (b) of FIG. 1 can perform the same functions as the transceivers illustrated in sub-drawing (a) of FIG. 1 described above. For example, the processing chip (114, 124) illustrated in sub-drawing (b) of FIG. 1 may include a processor (111, 121) and a memory (112, 122). The processor (111, 121) and the memory (112, 122) illustrated in sub-drawing (b) of FIG. 1 may perform the same functions as the processor (111, 121) and the memory (112, 122) illustrated in sub-drawing (a) of FIG. 1 described above.

The mobile terminal, wireless device, Wireless Transmit/Receive Unit (WTRU), User Equipment (UE), Mobile Station (MS), Mobile Subscriber Unit, user, user STA, network, Base Station, Node-B, Access Point (AP), repeater, router, relay, receiving device, transmitting device, receiving STA, transmitting STA, receiving Device, transmitting Device, receiving Apparatus, and/or transmitting Apparatus described below may refer to the STA (110, 120) illustrated in the sub-drawings (a)/(b) of FIG. 1, or may refer to the processing chip (114, 124) illustrated in the sub-drawing (b) of FIG. 1. That is, the technical feature of the present specification may be performed in the STA (110, 120) illustrated in the sub-drawings (a)/(b) of FIG. 1, or may be performed only in the processing chip (114, 124) illustrated in the sub-drawings (b) of FIG. 1. For example, the technical feature that the transmitting STA transmits a control signal may be understood as a technical feature that the control signal generated in the processor (111, 121) illustrated in the sub-drawings (a)/(b) of FIG. 1 is transmitted through the transceiver (113, 123) illustrated in the sub-drawings (a)/(b) of FIG. 1. Alternatively, the technical feature that the transmitting STA transmits a control signal may be understood as a technical feature that the control signal to be transmitted to the transceiver (113, 123) is generated in the processing chip (114, 124) illustrated in the sub-drawings (b) of FIG. 1.

For example, the technical feature of a receiving STA receiving a control signal can be understood as a technical feature of a control signal being received by a transceiver (113, 123) illustrated in sub-drawing (a) of FIG. 1. Alternatively, the technical feature of a receiving STA receiving a control signal can be understood as a technical feature of a control signal received by a transceiver (113, 123) illustrated in sub-drawing (a) of FIG. 1 being acquired by a processor (111, 121) illustrated in sub-drawing (a) of FIG. 1. Alternatively, the technical feature of a receiving STA receiving a control signal can be understood as a technical feature of a control signal received by a transceiver (113, 123) illustrated in sub-drawing (b) of FIG. 1 being acquired by a processing chip (114, 124) illustrated in sub-drawing (b) of FIG. 1.

Referring to sub-drawing (b) of FIG. 1, software code (115, 125) may be included in the memory (112, 122). The software code (115, 125) may include instructions that control the operation of the processor (111, 121). The software code (115, 125) may be included in various programming languages.

The processor (111, 121) or processing chip (114, 124) illustrated in FIG. 1 may include an application-specific integrated circuit (ASIC), another chipset, logic circuit, and/or data processing device. The processor may be an application processor (AP). For example, the processor (111, 121) or processing chip (114, 124) illustrated in FIG. 1 may include at least one of a digital signal processor (DSP), a central processing unit (CPU), a graphics processing unit (GPU), and a modem (modulator and demodulator). For example, the processors (111, 121) or processing chips (114, 124) illustrated in FIG. 1 may be a SNAPDRAGON® series processor manufactured by Qualcomm®, an EXYNOS® series processor manufactured by Samsung®, an A series processor manufactured by Apple®, a HELIO® series processor manufactured by MediaTek®, an ATOM® series processor manufactured by INTEL®, or an enhanced processor thereof.

In the present specification, “uplink” may refer to a link for communication from a non-AP STA to an AP STA, and uplink PPDUs/packets/signals, etc. may be transmitted via the uplink. Furthermore, in the present specification, “downlink” may refer to a link for communication from an AP STA to a non-AP STA, and downlink PPDUs/packets/signals, etc. may be transmitted via the downlink.

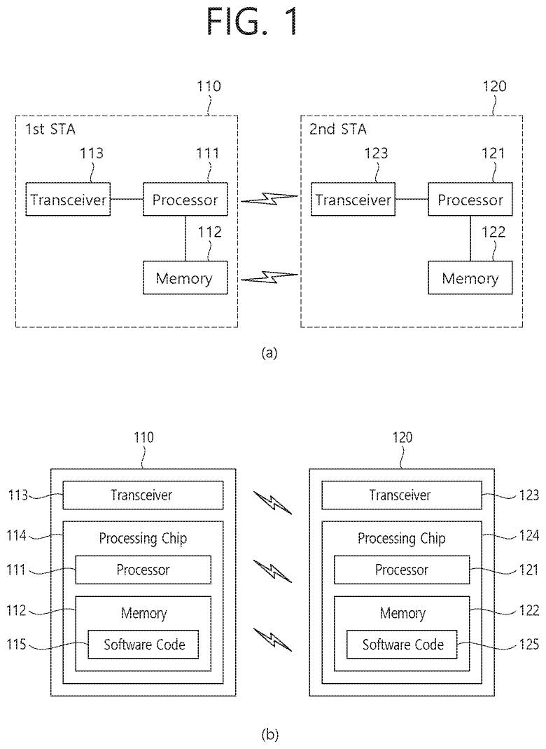

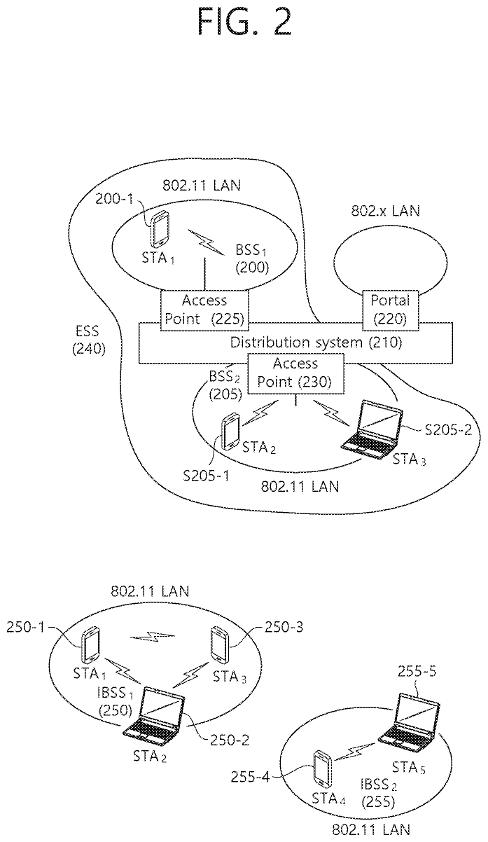

FIG. 2 is a conceptual diagram illustrating the structure of a wireless local area network (WLAN).

The top of FIG. 2 illustrates the structure of an infrastructure BSS (basic service set) of the Institute of Electrical and Electronic Engineers (IEEE) 802.11 standard.

Referring to the top of FIG. 2, the wireless LAN system may include one or more infrastructure BSSs (200, 205) (hereinafter referred to as BSS). A BSS (200, 205) is a set of APs (access points, 225) and STAs (stations, 200-1) that have successfully synchronized and can communicate with each other; it does not refer to a specific area. A BSS (205) may include one or more connectable STAs (205-1, 205-2) connected to a single AP (230).

A BSS may include at least one STA, an AP (225, 230) that provides a distribution service, and a distribution system (DS, 210) that connects multiple APs.

A distributed system (210) can connect multiple BSSs (200, 205) to implement an extended service set (ESS) 240. An ESS (240) can be used as a term to indicate a network formed by connecting one or more APs through the distributed system (210). APs included in a single ESS (240) can have the same SSID (service set identifier).

A portal (220) can serve as a bridge, connecting a wireless LAN network (IEEE 802.11) to another network (e.g., 802.X).

In a BSS, such as the upper portion of FIG. 2, a network between APs (225, 230) and a network between APs (225, 230) and STAs (200-1, 205-1, 205-2) can be implemented.

However, it may also be possible to establish a network and perform communication between STAs without an AP (225, 230). A network that establishes a network and performs communication between STAs without an AP (225, 230) is defined as an ad-hoc network or an independent basic service set (IBSS).

The bottom of FIG. 2 is a conceptual diagram illustrating an IBSS.

Referring to the bottom of FIG. 2, an IBSS is a BSS that operates in ad-hoc mode. Since an IBSS does not include an AP, there is no centralized management entity. That is, in the IBSS, STAs (250-1, 250-2, 250-3, 255-4, 255-5) are managed in a distributed manner. In IBSS, all STAs (250-1, 250-2, 250-3, 255-4, 255-5) can be mobile STAs, and access to distributed systems is not permitted, forming a self-contained network.

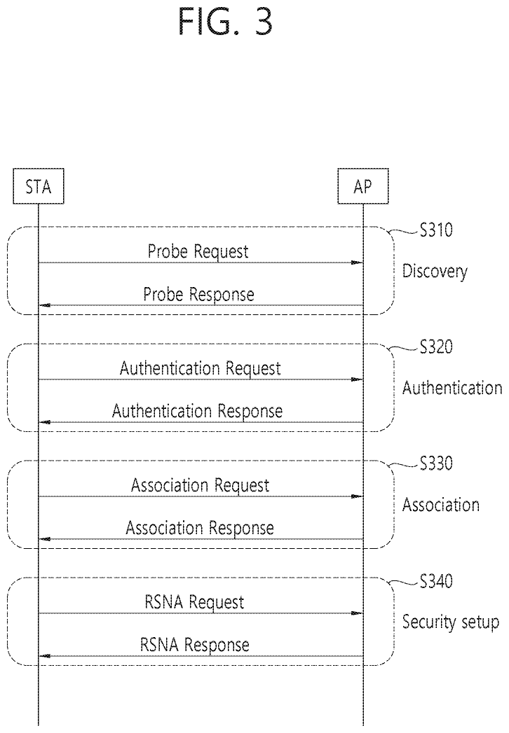

FIG. 3 is a diagram illustrating a typical link setup process.

In the illustrated step S310, a STA may perform a network discovery operation. This network discovery operation may include scanning. That is, for a STA to access a network, it must find a network it can join. Before joining a wireless network, a STA must identify compatible networks. The process of identifying networks in a specific area is called scanning. Scanning methods include active scanning and passive scanning.

FIG. 3 illustrates a network discovery operation that includes an active scanning process as an example. In active scanning, a STA performing scanning transmits a probe request frame to discover nearby APs while moving through channels and awaits a response. The responder transmits a probe response frame to the STA that transmitted the probe request frame in response to the probe request frame. Here, the responder may be the STA that last transmitted a beacon frame in the BSS of the channel being scanned. In a BSS, the AP transmits the beacon frame, making it the responder. In an IBSS, STAs within the IBSS take turns transmitting beacon frames, so the responder is not fixed. For example, a STA that transmits a probe request frame on channel 1 and receives a probe response frame on channel 1 may store the BSS-related information contained in the received probe response frame and move to the next channel (e.g., channel 2) to perform scanning in the same manner (e.g., transmitting and receiving probe requests and responses on channel 2).

Although not shown in the example of FIG. 3, the scanning operation can also be performed passively. A STA performing scanning based on passive scanning may wait for a beacon frame while moving between channels. A beacon frame, a management frame in IEEE 802.11, announces the presence of a wireless network and is periodically transmitted to scanning STAs to discover and join the network. In the BSS, the AP periodically transmits beacon frames, while in the IBSS, STAs within the IBSS take turns transmitting beacon frames. When a scanning STA receives a beacon frame, it stores the BSS information contained in the beacon frame and moves to a different channel, recording the beacon frame information on each channel. Upon receiving a beacon frame, the STA stores the BSS-related information contained in the received beacon frame and moves to the next channel, performing scanning on the next channel using the same method.

A STA that discovers a network can perform an authentication process in step S320. This authentication process can be referred to as the first authentication process to clearly distinguish it from the security setup operation of step S340, described below. The authentication process of S320 may include a process in which the STA transmits an authentication request frame to the AP, and the AP transmits an authentication response frame to the STA in response. The authentication frame used for the authentication request/response corresponds to a management frame.

The authentication frame may include information such as an authentication algorithm number, an authentication transaction sequence number, a status code, a challenge text, a Robust Security Network (RSN), and a Finite Cyclic Group (FCG).

The STA may transmit the authentication request frame to the AP. The AP may determine whether to grant authentication to the STA based on the information contained in the received authentication request frame. The AP may provide the STA with the result of the authentication process via an authentication response frame.

A successfully authenticated STA may perform the connection process based on step S330. The association process involves the STA sending an association request frame to the AP, and the AP responding by sending an association response frame to the STA. For example, the association request frame may include information related to various capabilities, such as a beacon listen interval, a service set identifier (SSID), supported rates, supported channels, RSN, mobility domain, supported operating classes, a Traffic Indication Map Broadcast request, and interworking service capabilities. For example, the association response frame may include information related to various capabilities, status codes, Association ID (AID), supported rates, Enhanced Distributed Channel Access (EDCA) parameter sets, Received Channel Power Indicator (RCPI), Received Signal to Noise Indicator (RSNI), mobility domains, timeout intervals (association comeback times), overlapping BSS scan parameters, TIM broadcast responses, QoS maps, etc.

Subsequently, in step S340, the STA may perform a security setup process. The security setup process in step S340 may include, for example, a process of setting up a private key through four-way handshaking using an Extensible Authentication Protocol over LAN (EAPOL) frame.

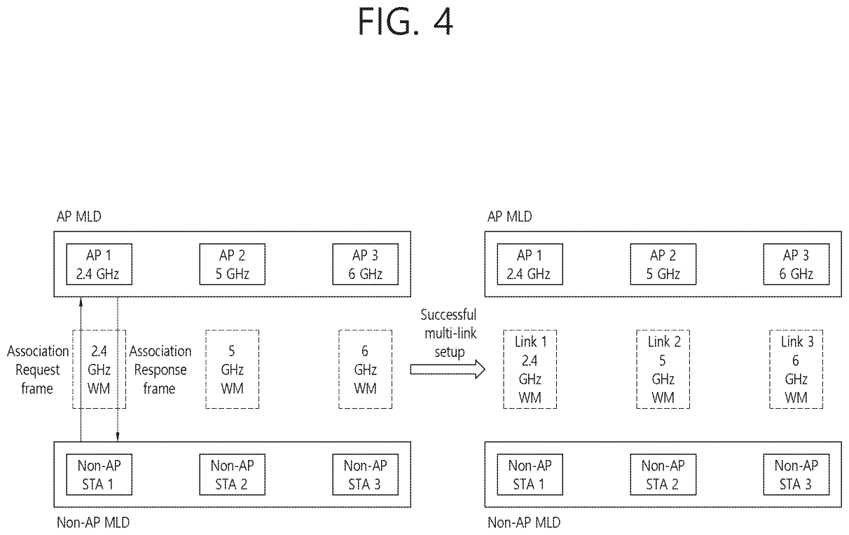

FIG. 4 illustrates an embodiment of a multi-link (ML).

As illustrated in FIG. 4, multiple multi-link devices (MLDs) can communicate via a multi-link. The MLDs can be categorized into AP MLDs, which include multiple AP STAs, and non-AP MLDs, which include multiple non-AP STAs. Specifically, the AP MLD may include affiliated APs (e.g., AP STAs), and the non-AP MLD may include affiliated STAs (e.g., non-AP STAs, or user-STAs).

The multi-link may include a first link and a second link, and different channels/subchannels/frequency resources may be allocated to the first and second links. The first and second multi-links may be identified using a 4-bit (or other n-bit) link ID. The first and second links may be configured in the same 2.4 GHz, 5 GHZ, or 6 GHz band. Alternatively, the first and second links may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link, in which AP1 and non-AP1 operate, may be defined as a channel/subchannel/frequency resource within the 2.4 GHz band.

Furthermore, in the example of FIG. 4, the second link, in which AP2 and non-AP2, may be defined as a channel/subchannel/frequency resource within the 5 GHz band. Additionally, in the example of FIG. 4, the third link where AP3 and non-AP3 operate can be defined as a channel/subchannel/frequency resource within the 6 GHz band.

In the example of FIG. 4, AP1 can initiate a multilink setup procedure (ML setup procedure) by transmitting an Association Request frame to non-AP STAI. In the example of FIG. 4, non-AP STAI can transmit an Association Response frame in response to the Association Request frame. Each AP (e.g., AP1 /2/3) depicted in FIG. 4 may be identical to the APs depicted in FIG. 1 and/or FIG. 2, and each non-AP (e.g., non-AP1 /2/3) depicted in FIG. 4 may be identical to the STAs (e.g., user STAs or non-AP STAs) depicted in FIG. 1 and/or FIG. 2.

The specific features of the present specification are not limited to the specific features depicted in FIG. 4. That is, the number of links can be defined in various ways, and multiple links can be defined in various ways within at least one band.

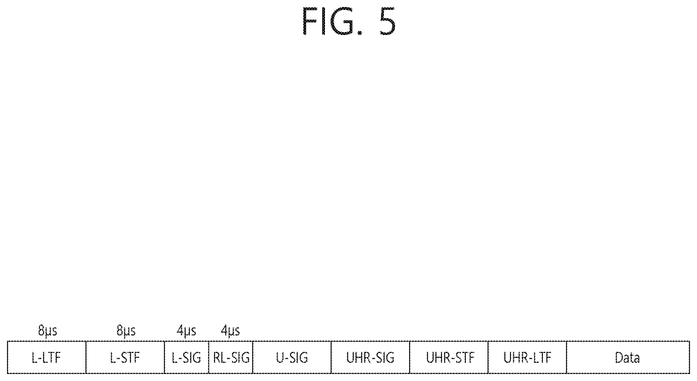

FIG. 5 illustrates a PPDU (physical protocol data unit or physical layer (PHY) protocol data unit) transmitted/received by a STA of the present specification.

A STA (e.g., an AP STA, a non-AP STA, an AP MLD, or a non-AP MLD) of the present specification can transmit and/or receive the PPDU of FIG. 5. The PPDU described herein may have, for example, the structure of FIG. 5. Furthermore, the PPDU described herein, an Ultra High Reliability (UHR) PPDU, may be referred to by various names, such as a transmission PPDU, a reception PPDU, a first type PPDU, or an Nth type PPDU. The PPDU described herein may be used in a WLAN system defined according to IEEE 802.11bn and/or a next-generation WLAN system that enhances IEEE 802.11bn.

The PPDU of FIG. 5 may relate to various PPDU types used in a UHR system. For example, the example of FIG. 5 can be used for at least one of single-user (SU) mode/type/transmission, multi-user (MU) mode/type/transmission, and null data packet (NDP) mode/type/transmission related to channel sounding. For example, if the example of FIG. 5 relates to NDP, the illustrated Data field may be omitted. If the PPDU of FIG. 5 is used for Trigger-based (TB) mode, the UHR-SIG of FIG. 5 may be omitted. In other words, a STA that has received a Trigger frame for UL-MU (Uplink-MU) communication may transmit a PPDU with the UHR-SIG omitted in the example of FIG. 5.

In FIG. 5, L-STF or UHR-LTF may be referred to as a preamble or physical preamble, and may be generated/transmitted/received/acquired/decoded in the physical layer (included in the transmitting/receiving STA).

Each block illustrated in FIG. 5 may be referred to as a field/subfield/signal, etc. The names of these fields/subfields/signals may be, as illustrated in FIG. 5, a legacy short training field (L-STF), a legacy long training field (L-LTF), a legacy signal (L-SIG), a repeated L-SIG (RL-SIG), Universal Signal (U-SIG), UHR-signal (UHR-SIG), etc.

The subcarrier spacing of the L-STF, L-LTF, L-SIG, RL-SIG, U-SIG, and UHR-SIG fields in FIG. 5 may be set to 312.5 kHz, and the subcarrier spacing of the UHR-STF, UHR-LTF, and Data fields may be set to 78.125 kHz. That is, the tone indices (or subcarrier indices) of the L-STF, L-LTF, L-SIG, RL-SIG, U-SIG, and UHR-SIG fields may be expressed in units of 312.5 kHz, and the tone indices (or subcarrier indices) of the UHR-STF, UHR-LTF, and Data fields may be expressed in units of 78.125 kHz.

In the PPDU in FIG. 5, L-LTF and L-STF may be identical to conventional fields (e.g., non-HT LTF and non-HT STF defined in conventional WLAN standards).

The L-SIG field of FIG. 5 may include, for example, 24 bits of bit information. For example, the 24 bits of information may include a 4 bit Rate field, a 1 bit Reserved bit, a 12 bit Length field, a 1 bit Parity bit, and a 6 bit Tail bit. For example, the 12 bit Length field may include information about the length or time duration of the PPDU. For example, the value of the 12 bit Length field may be determined based on the type of the PPDU. For example, if the PPDU is a non-HT (non-High Throughput), HT (High Throughput), VHT (Very High Throughput) PPDU, or an EHT (extremely high throughput) PPDU or UHR PPDU, the value of the Length field may be determined as a multiple of 3. For example, if the PPDU is a HE PPDU, the value of the Length field may be determined as “a multiple of 3+1” or “a multiple of 3+2”. In other words, for non-HT, HT, VHT PPDUs, EHT PPDUs, and UHR PPDUs, the Length field value can be determined as a multiple of 3. For HE (High Efficiency) PPDUs, the Length field value can be determined as “a multiple of 3+1” or “a multiple of 3+2.” In other words, the Length field in a UHR PPDU is set to a value satisfying the condition that the remainder is zero when LENGTH is divided by 3.

For example, a (non-AP and AP) STA can apply BCC encoding based on a code rate of ½ to the 24-bit information in the L-SIG field. The transmitting STA can then acquire 48 BCC encoding bits. BPSK modulation can be applied to the 48 encoding bits, generating 48 BPSK symbols. The transmitting STA can map 48 BPSK symbols to positions other than the pilot subcarriers {subcarrier indices −21, −7, +7, +21} and the DC subcarrier {subcarrier index 0}.

Consequently, the 48 BPSK symbols can be mapped to subcarrier indices −26 to −22, −20 to −8, −6 to −1, +1 to +6, +8 to +20, and +22 to +26. The transmitting STA can additionally map signals {−1, −1, −1, 1} to subcarrier indices {−28, −27, +27, +28}. These signals can be used for channel estimation for the frequency domain corresponding to {−28, −27, +27, +28}.

For example, (non-AP and AP) STAs can generate RL-SIGs that are generated identically to L-SIGs. BPSK modulation can be applied to RL-SIG. The receiving (non-AP and AP) STA can determine whether the received PPDU is a HE PPDU, EHT PPDU, or UHR PPDU based on the presence of RL-SIG. In other words, the receiving (non-AP and AP) STA can determine whether the received PPDU is a HE PPDU, EHT PPDU, or UHR PPDU if RL-SIG is present. In other words, the receiving (non-AP and AP) STA can determine whether the received PPDU is a non-HT PPDU, HT PPDU, or VHT PPDU if RL-SIG is not present. In other words, the RL-SIG field is a repeat of the L-SIG field and is used to differentiate a UHR PPDU from a non-HT PPDU, HT PPDU, and VHT PPDU.

A Universal Signal (U-SIG) may be inserted after the RL-SIG in FIG. 5. The U-SIG may be referred to by various names, such as the first SIG field, the first SIG, the first type SIG, the control signal, the control signal field, the first (type) control signal, the common control field, and the common control signal.

The U-SIG may contain N bits of information and may include information for identifying the type of the EHT PPDU. For example, the U-SIG may be composed based on two symbols (e.g., two consecutive/contiguous OFDM symbols). Each symbol for the U-SIG (e.g., the OFDM symbol) may have a duration of 4 μs. Each symbol of the U-SIG may be used to transmit 26 bits of information. For example, each symbol of the U-SIG may be transmitted and received based on 52 data tones and 4 pilot tones.

For example, A bit information (e.g., 52 uncoded bits) can be transmitted through U-SIG, and the first symbol of U-SIG can transmit the first X bits of information (e.g., 26 uncoded bits) out of the total A bit information, and the second symbol of U-SIG can transmit the remaining Y bits of information (e.g., 26 uncoded bits) out of the total A bit information. For example, the transmitting STA can obtain 26 uncoded bits included in each U-SIG symbol. The transmitting STA can perform convolutional encoding (e.g., BCC encoding) based on a rate of R=1/2 to generate 52 coded bits, and perform interleaving on the 52 coded bits. The transmitting STA can perform BPSK modulation on the interleaved 52 BPSK symbols to generate 52 BPSK symbols allocated to each U-SIG symbol. A single U-SIG symbol can be transmitted based on 56 tones (subcarriers) ranging from subcarrier index −28 to subcarrier index +28, excluding DC index 0. The 52 BPSK symbols generated by the transmitting STA can be transmitted based on the remaining tones (subcarriers) excluding the pilot tones −21, −7, +7, and +21.

For example, the A-bit information (e.g., 52 uncoded bits) transmitted by the U-SIG can include a CRC field (e.g., a 4-bit field) and a tail field (e.g., a 6-bit field). The CRC field and tail field can be transmitted via the second symbol of the U-SIG. The CRC field can be generated based on the 26 bits allocated to the first symbol of the U-SIG and the remaining 16 bits within the second symbol, excluding the CRC/tail field, and can be generated based on a conventional CRC calculation algorithm. Additionally, the tail field can be used to terminate the trellis of the convolutional decoder and can be set to “000000,” for example.

The A-bit information (e.g., 52 uncoded bits) transmitted by the U-SIG (or U-SIG field) can be divided into version-independent bits and version-dependent bits. For example, the size of the version-independent bits can be fixed or variable. For example, the version-independent bits can be assigned only to the first symbol of the U-SIG, or the version-independent bits can be assigned to both the first and second symbols of the U-SIG. For example, the version-independent bits and version-dependent bits can be referred to by various names, such as the first control bit and the second control bit.

For example, the version-independent bits of the U-SIG can include a 3-bit PHY version identifier. For example, a 3-bit PHY version identifier may include information related to the PHY version of a transmitted/received PPDU. For example, a first value (e.g., a value of 000) of the 3-bit PHY version identifier may indicate that the transmitted/received PPDU is an EHT PPDU. Additionally, a second value (e.g., a value of 001) of the 3-bit PHY version identifier may indicate that the transmitted/received PPDU is a UHR PPDU.

In other words, when an (AP/non-AP) STA transmits an EHT PPDU, it may set the 3-bit PHY version identifier to the first value. In other words, a receiving (AP/non-AP) STA may determine that the received PPDU is an EHT PPDU based on a PHY version identifier having the first value, and may determine that the received PPDU is a UHR PPDU based on a PHY version identifier having the second value.

For example, the version-independent bits of U-SIG may include a 1-bit UL/DL flag field. The first value of the 1-bit UL/DL flag field relates to UL communication, and the second value of the UL/DL flag field relates to DL communication.

For example, the version-independent bits of the U-SIG may include information about the length of the TXOP and information about the BSS color ID.

For example, if the UHR PPDU is classified into various types (e.g., a type related to SU transmission (performed based on UL or DL), a type related to DL transmission, a type related to NDP transmission, a type related to DL non-MU-MIMO, a type related to DL MU-MIMO, a type related to Multi-AP operation, a type related to CBF (Coordinated beamforming), SR (Spatial Reuse), a type related to C-OFDMA (Coordinated OFDMA), a type related to C-TDMA (Coordinated TDMA)), information about the type of the EHT PPDU (e.g., 2-bit or 3-bit information) may be included in the version-dependent bits of the U-SIG.

For example, U-SIG may include 1) a bandwidth field including information about bandwidth, 2) a field including information about the Modulation and Coding Scheme (MCS) technique applied to UHR-SIG, 3) an indication field including information about whether dual subcarrier modulation (DCM) technique is applied to UHR-SIG, 4) a field including information about the number of symbols used for UHR-SIG, 5) a field including information about whether UHR-SIG is generated across the entire band, 6) a field including information about the type of UHR-LTF/STF, and 7) a field indicating the length of UHR-LTF and the CP length.

Preamble puncturing may be applied to the PPDU of FIG. 5. Preamble puncturing means applying puncturing to a portion of the entire band of the PPDU (e.g., the secondary 20 MHz band). For example, when an 80 MHz PPDU is transmitted, the STA can apply puncturing to the secondary 20 MHz band within the 80 MHz band and transmit the PPDU only through the primary 20 MHz band and the secondary 40 MHz band.

For example, the preamble puncturing pattern can be preset. For example, if the first puncturing pattern is applied, puncturing can be applied only to the secondary 20 MHz band within the 80 MHz band. For example, if the second puncturing pattern is applied, puncturing can be applied only to one of the two secondary 20 MHz bands included in the secondary 40 MHz band within the 80 MHz band. For example, if the third puncturing pattern is applied, puncturing can be applied only to the secondary 20 MHz band included in the primary 80 MHz band within the 160 MHz band (or 80+80 MHz band). For example, when the fourth puncturing pattern is applied, puncturing may be applied to at least one 20 MHz channel not included in the primary 40 MHz band, while the primary 40 MHz band is present within the 160 MHz band (or the 80+80 MHz band).

Information related to preamble puncturing applied to a PPDU may be included in the U-SIG and/or UHR-SIG. For example, the first field of the U-SIG may include information related to the contiguous bandwidth of the PPDU, and the second field of the U-SIG may include information related to preamble puncturing applied to the PPDU.

For example, the U-SIG and UHR-SIG may include information related to preamble puncturing based on the following method. If the bandwidth of the PPDU exceeds 80 MHz, the U-SIG may be configured individually in 80 MHz units. For example, if the bandwidth of a PPDU is 160 MHz, the PPDU may include a first U-SIG for a first 80 MHz band and a second U-SIG for a second 80 MHz band. In this case, a first field of the first U-SIG may include information about the 160 MHz bandwidth, and a second field of the first U-SIG may include information about preamble puncturing applied to the first 80 MHz band (e.g., information about a preamble puncturing pattern). In addition, a first field of the second U-SIG may include information about the 160 MHz bandwidth, and a second field of the second U-SIG may include information about preamble puncturing applied to the second 80 MHz band (e.g., information about a preamble puncturing pattern). Meanwhile, the UHR-SIG contiguous to the first U-SIG may include information about preamble puncturing applied to the second 80 MHz band (e.g., information about a preamble puncturing pattern), and the UHR-SIG contiguous to the second U-SIG may include information about preamble puncturing applied to the first 80 MHz band (e.g., information about a preamble puncturing pattern).

Additionally or alternatively, the U-SIG and UHR-SIG may include information related to preamble puncturing based on the following methods. The U-SIG may include information related to preamble puncturing for all bands (e.g., information related to the preamble puncturing pattern). That is, the UHR-SIG does not include information related to preamble puncturing, and only the U-SIG may include information related to preamble puncturing (e.g., information related to the preamble puncturing pattern).

The U-SIG may be configured in 20 MHz units. For example, if an 80 MHz PPDU is configured, the U-SIG may be duplicated. That is, four identical U-SIGs may be included within the 80 MHz PPDU. PPDUs exceeding the 80 MHz bandwidth may include different U-SIGs.

The UHR-SIG of FIG. 5 may include control information for a receiving STA. The UHR-SIG may be transmitted over at least one symbol, each symbol having a length of 4 μs. Information related to the number of symbols used for the UHR-SIG may be included in the U-SIG.

The UHR-SIG provides additional signals to the U-SIG field to enable the STA to interpret/decode the UHR PPDU. The UHR-SIG field may include U-SIG overflow bits common to all users. The UHR-SIG field also includes resource allocation information, allowing the STA to look up resources used in fields including the data field, UHR-STF, and UHR-LTF (e.g., UHR modulated fields of a UHR PPDU).

The frequency resources of the UHR-LTF, UHR-STF, and data fields illustrated in FIG. 5 can be determined based on resource units (RUs) defined by multiple subcarriers/tones. That is, the UHR-LTF, UHR-STF, and data fields of the present specification can be transmitted/received via resource units (RUs) defined by multiple subcarriers/tones.

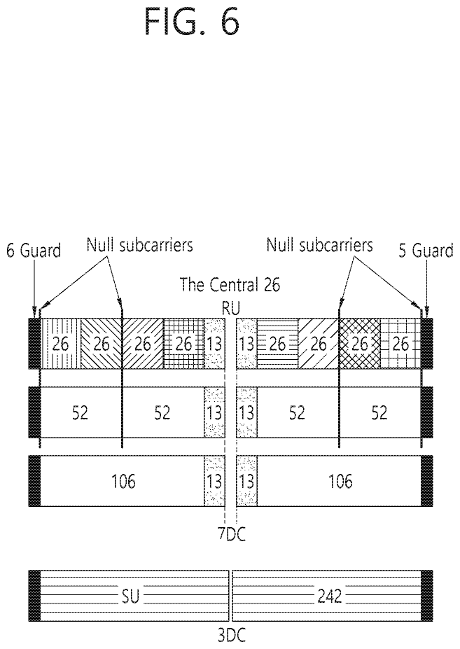

FIG. 6 is a diagram illustrating the layout of resource units (RUs) used for a 20 MHz PPDU. That is, the UHR-LTF, UHR-STF, and/or data fields included in a 20 MHz PPDU can be transmitted/received via at least one of the various RUs defined in FIG. 6.

As illustrated at the top of FIGS. 6, 26 units (e.g., units corresponding to 26 tones) can be arranged. In the leftmost band of the 20 MHz band, six tones can be used as a guard band, and in the rightmost band of the 20 MHz band, five tones can be used as a guard band. Furthermore, seven DC tones can be inserted into the center band (i.e., the DC band), and 26 units, corresponding to 13 tones each, can exist on the left and right sides of the DC band. Furthermore, 26, 52, and 106 units can be allocated to other bands. Each unit can be assigned to a receiving station, i.e., a user.

Meanwhile, the RU arrangement of FIG. 6 can be utilized not only for multiple users (MUs) but also for single users (SUs). In this case, as shown at the bottom of FIG. 6, a single 242-unit can be used, in which case three DC tones can be inserted.

In the example of FIG. 6, RUs of various sizes, such as 26-RU, 52-RU, 106-RU, and 242-RU, are proposed. Since the specific sizes of these RUs can be expanded or increased, the present embodiment is not limited to the specific sizes of each RU (e.g., the number of corresponding tones). In the present specification, N-RU may be represented as N-tone RU, etc. For example, 26-RU may be represented as 26-tone RU.

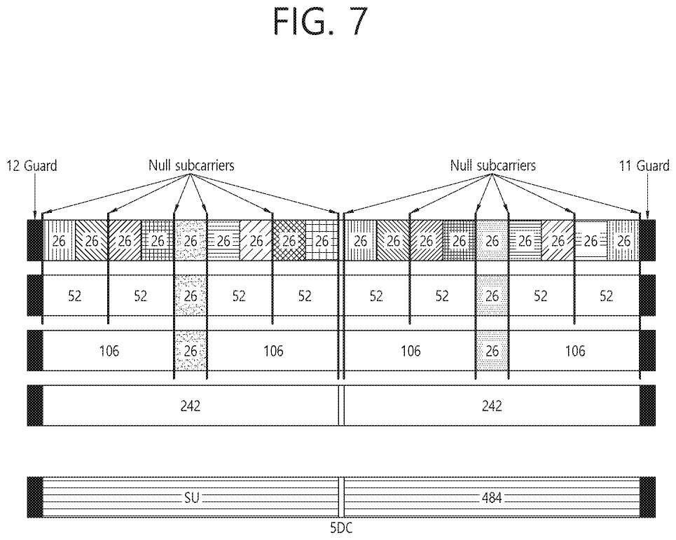

FIG. 7 is a diagram illustrating the layout of resource units (RUS) used for a 40 MHZ PPDU.

Similar to the example in FIG. 6, which used RUs of various sizes, the example in FIG. 7 can also use RUs of 26, 52, 106, 242, and 484 RUs. Furthermore, five DC tones can be inserted at the center frequency, 12 tones can be used as guard bands in the leftmost band of the 40 MHz band, and 11 tones can be used as guard bands in the rightmost band of the 40 MHz band.

Also, as illustrated, a 484-RU can be used for a single user. Similarly to the example in FIG. 6, the specific number of RUs can be varied.

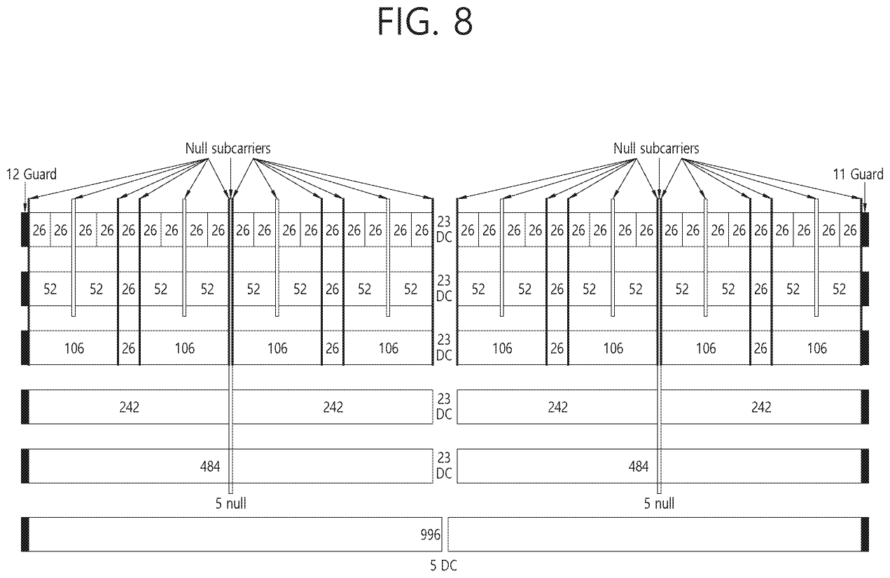

FIG. 8 is a diagram illustrating the layout of resource units (RUs) used for an 80 MHZ PPDU. The arrangement of resource units (RUs) used in the present specification may vary. For example, the arrangement of resource units (RUs) used in the 80 MHz band may vary.

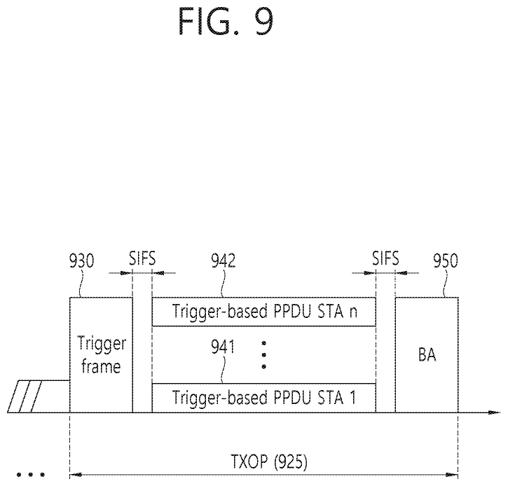

FIG. 9 illustrates the operation according to UL-MU. As illustrated, a transmitting STA (e.g., an AP) may acquire a TXOP (925) by performing channel access through contending (e.g., backoff operation) and transmit a Trigger frame (930). That is, the transmitting STA (e.g., an AP) may transmit a PPDU including the Trigger frame (930). Upon receiving the PPDU including the Trigger frame, a TB (trigger-based) PPDU is transmitted after a delay equal to SIFS.

TB PPDUs (941, 942) are transmitted at the same time and may be transmitted from multiple STAs (e.g., user STAs) whose AIDs are indicated in the Trigger frame (930). The ACK frame (950) for the TB PPDU can be implemented in various forms. For example, the ACK frame (950) for the TB PPDU can be implemented in the form of a BA (block ACK).

In FIG. 9, transmission(s) of the Trigger Frame (930), TB PPDUs (941, 942), and/or the ACK frame (950) can be performed within the TXOP (925).

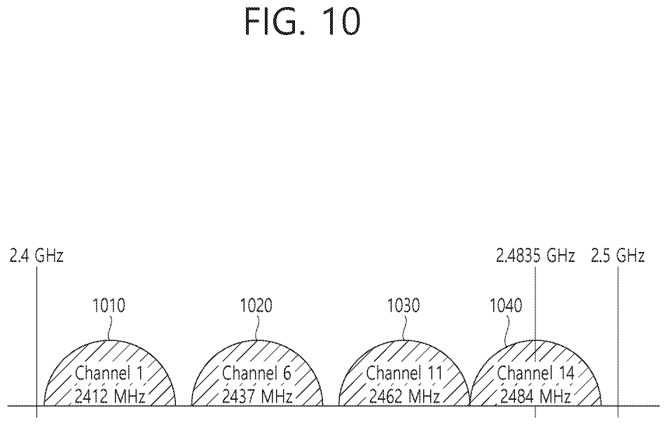

FIG. 10 illustrates an example of channels used/supported/defined within the 2.4 GHz band.

The 2.4 GHz band may also be referred to by other names, such as the first band (band). Furthermore, the 2.4 GHz band may refer to a frequency region in which channels with a center frequency adjacent to 2.4 GHz (e.g., channels with a center frequency between 2.4 and 2.5 GHZ) are used/supported/defined.

The 2.4 GHz band may include multiple 20 MHz channels. Each 20 MHz channel within the 2.4 GHz band may have multiple channel indices (e.g., indices 1 through 14). For example, the center frequency of a 20 MHz channel assigned channel index 1 may be 2.412 GHz, the center frequency of a 20 MHz channel assigned channel index 2 may be 2.417 GHz, and the center frequency of a 20 MHz channel assigned channel index N may be (2.407+0.005*N) GHz. Channel indices may be referred to by various names, such as channel numbers. The specific numerical values of the channel indices and center frequencies may vary.

FIG. 10 illustrates four channels within the 2.4 GHz band. The illustrated first frequency region (1010) through fourth frequency region (1040) may each include one channel. For example, the first frequency domain (1010) may include channel 1 (a 20 MHz channel having an index of 1). At this time, the center frequency of channel 1 may be set to 2412 MHz. The second frequency domain (1020) may include channel 6. At this time, the center frequency of channel 6 may be set to 2437 MHz. The third frequency domain (1030) may include channel 11. At this time, the center frequency of channel 11 may be set to 2462 MHz. The fourth frequency domain (1040) may include channel 14. At this time, the center frequency of channel 14 may be set to 2484 MHZ.

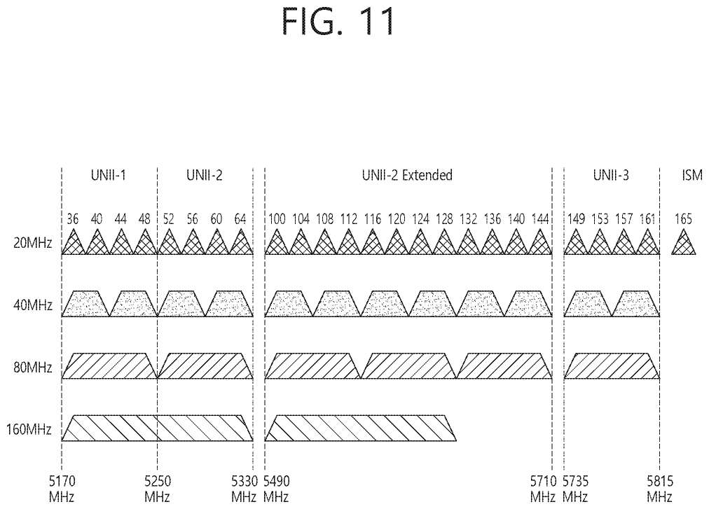

FIG. 11 illustrates an example of channels used/supported/defined within the 5 GHZ band.

The 5 GHz band may also be referred to as a second band, etc. The 5 GHz band may refer to a frequency region in which channels with a center frequency greater than or equal to 5 GHz and less than 6 GHz (or less than 5.9 GHZ) are used/supported/defined. Alternatively, the 5 GHz band may include multiple channels between 4.5 GHz and 5.5 GHz. The specific figures shown in FIG. 11 are subject to change.

The multiple channels within the 5 GHz band include Unlicensed National Information Infrastructure (UNII)-1, UNII-2, UNII-3, and ISM. UNII-1 may be referred to as UNII Low.

UNII-2 may include frequency regions called UNII Mid and UNII-2 Extended. UNII-3 may be referred to as UNII-Upper.

Multiple channels can be configured within the 5 GHz band, and the bandwidth of each channel can be variously configured, such as 20 MHz, 40 MHz, 80 MHz, or 160 MHz. For example, the 5170 MHz to 5330 MHz frequency region within UNII-1 and UNII-2 can be divided into eight 20 MHz channels. The 5170 MHz to 5330 MHz frequency region can be divided into four channels via a 40 MHz frequency band. The 5170 MHz to 5330 MHz frequency region can be divided into two channels via an 80 MHz frequency band. Alternatively, the 5170 MHz to 5330 MHz frequency region can be divided into one channel via a 160 MHz frequency band.

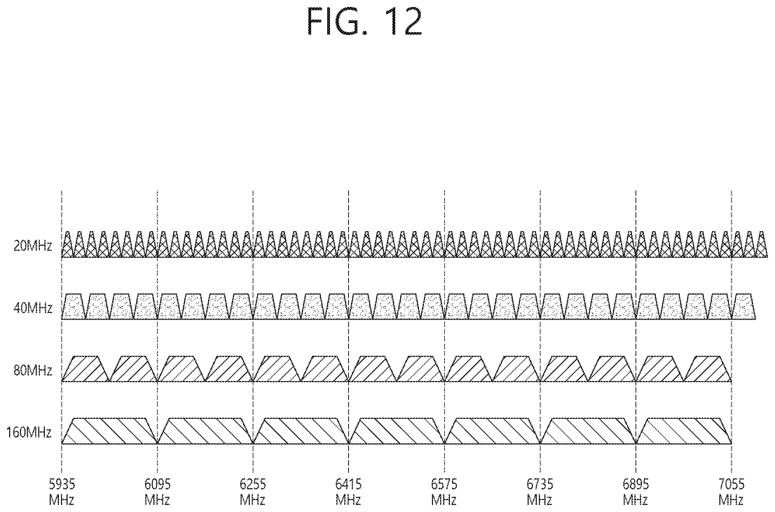

FIG. 12 illustrates an example of channels used/supported/defined within the 6 GHZ band.

The 6 GHz band may be referred to by other names, such as the third band/band. The 6 GHz band may refer to a frequency region where channels with a center frequency of 5.9 GHz or higher are used, supported, or defined. The specific values shown in FIG. 12 may vary.

For example, the 20 MHz channel in FIG. 12 may be defined starting from 5.940 GHz. Specifically, the leftmost channel among the 20 MHz channels in FIG. 12 may have an index of 1 (or channel index, channel number, etc.) and may be assigned a center frequency of 5.945 GHz. In other words, the center frequency of channel index N may be determined as (5.940+0.005*N) GHz.

Accordingly, the indices (or channel numbers) of the 20 MHz channels in FIG. 12 are 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. Additionally, according to the aforementioned (5.940+0.005*N) GHz rule, the indices of the 40 MHz channels in FIG. 12 can be 3, 11, 19, 27, 35, 43, 51, 59, 67, 75, 83, 91, 99, 107, 115, 123, 131, 139, 147, 155, 163, 171, 179, 187, 195, 203, 211, 219, and 227.

Hereinafter, the structure, type and/or sub-type of the MAC frame are described.

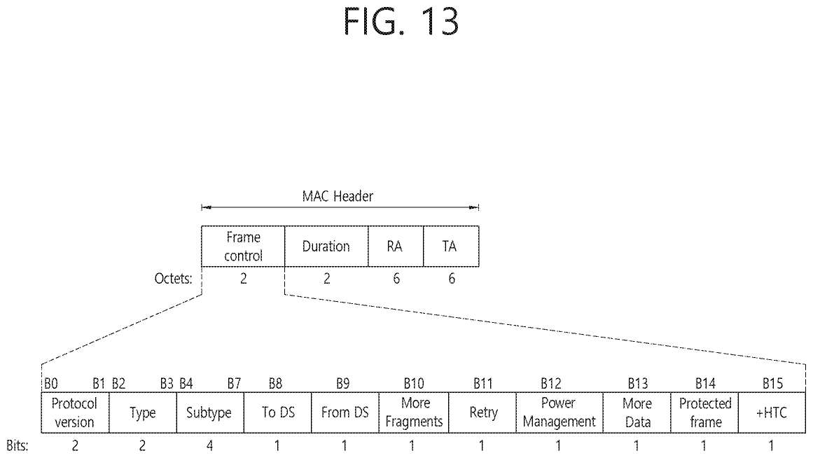

FIG. 13 illustrates an example of a MAC frame header. As illustrated, the MAC frame may include a 2-octet frame control field/information, a 2-octet duration field/information, a 6-octet RA (Receiver Address) field/information, and a 6-octet TA (Transmitter Address) field/information. As illustrated in FIG. 13, the four fields may be contiguous. The MAC header of FIG. 13 may be modified in various ways, with new fields inserted between the four fields illustrated, or at least one of the fields illustrated may be omitted.

The MAC header illustrated in FIG. 13 may be positioned at the very beginning of the MAC frame. That is, the MAC frame may include a MAC header as illustrated in FIG. 13 and a MAC body field/information contiguous to the MAC header. The MAC frame including the MAC header of FIG. 13 is inserted/included in the data field of the PPDU (e.g., UHR PPDU) illustrated in FIG. 5.

The MAC frames included in the data field of the PPDU of the present specification can be classified into various types. For example, the MAC frames of the present specification can be classified into control frames, management frames, and data frames.

For example, the management frame includes the Association Request, Association Response, Reassociation Request, Reassociation Response, Probe Request, Probe Response, Beacon, Disassociation, Authentication, and Deauthentication frames/signals defined in conventional WLANs. For the management frame, the type fields (B3 and B2) in FIG. 13 are set to 00. Additionally, the values of the subtype fields (B7, B6, B5, B4) in FIG. 13 are as follows: Association Request (0000), Association Response (0001), Reassociation Request (0010), Reassociation Response (0011), Probe Request (0100), Probe Response (0101), Beacon (1000), Disassociation (1010), Authentication (1011), Deauthentication (1100).

For example, the control frame includes the Trigger Beamforming Report Poll, NDP Announcement (NDPA), Control Frame Extension, Control Wrapper, Block Ack Request (BlockAckReq), Block Ack (BlockAck), PS-Poll, RTS, CTS, Ack, and CF-End frames/signals defined in conventional WLANs. For the control frame, the values of the type fields (B3 and B2) in FIG. 13 are set to 01. Additionally, the values of the subtype fields (B7, B6, B5, B4) in FIG. 13 are as follows: Trigger (0010), Beamforming Report Poll (0100), NDP Announcement (0101), Control Frame Extension (0110), Control Wrapper (0111), BlockAckReq (1000), BlockAck (1001), PS-Poll (1010), RTS (1011), CTS (1100), Ack (1101), CF-End (1110).

For example, the data frame includes (QoS) Data, (QoS) Null, etc., as defined in conventional WLANs. For the data frame, the values of the type fields (B3 and B2) in FIG. 13 are set to 10.

The MAC frames/signals used in the present specification can be identified through the type field/information and subtype field/information described above. For example, a “trigger frame” in the present specification may refer to a MAC frame in which the type bits B3 and B2 in the frame control field of the MAC header are set to 01, while the subtype bits B7, B6, B5, and B4 in the frame control field are set to 0010. The various MAC frames described in the present specification are inserted/included in the data fields of various PPDUs (e.g., HE/VHT/HE/EHT/UHR PPDUs).

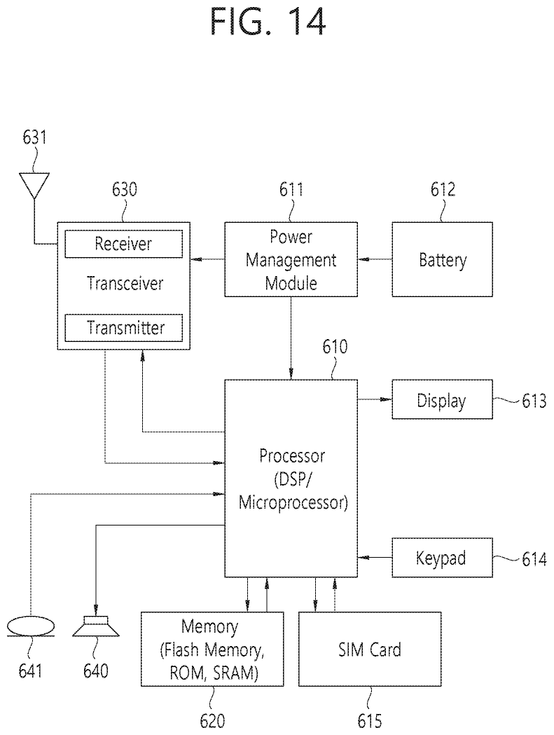

FIG. 14 illustrates a modified example of a transmitting device and/or receiving device of the present specification.

The devices (e.g., AP STAs, non-AP STAs) illustrated in FIGS. 1 to 4 may be modified as illustrated in FIG. 14. The transceiver (630) in FIG. 14 may be identical to the transceivers (113, 123) in FIG. 1. The transceiver (630) of FIG. 14 may include a receiver and a transmitter.

The processor (610) of FIG. 14 may be identical to the processors (111, 121) of FIG. 1. Alternatively, the processor (610) of FIG. 14 may be identical to the processing chip (114, 124) of FIG. 1.

The memory (150) of FIG. 14 may be identical to the memory (112, 122) of FIG. 1.

Alternatively, the memory (150) of FIG. 14 may be a separate external memory different from the memory (112, 122) of FIG. 1.

Referring to FIG. 14, the power management module (611) manages power for the processor (610) and/or the transceiver (630). The battery (612) supplies power to the power management module (611). The display (613) outputs the results processed by the processor (610). The keypad (614) receives input to be used by the processor (610). The keypad (614) may be displayed on the display (613). The SIM card (615) may be an integrated circuit used to securely store an international mobile subscriber identity (IMSI) and associated keys, which are used to identify and authenticate subscribers in mobile devices such as mobile phones and computers.

Referring to FIG. 14, the speaker (640) may output sound-related results processed by the processor (610). The microphone (641) may receive sound-related input to be used by the processor (610).

Hereinafter, the technical feature of the present specification is described in more detail.

The maximum duration of a PPDU based on HT/VHT/HE/EHT/UHR may be up to 5.484 ms. For example, in the IEEE 802.11 standard, the maximum duration of a PPDU can be determined based on a parameter called aPPDUmaxtime.

The present specification may be related to a new type/format/category of PPDU that improves upon a conventional PPDU. For example, the new type/format/category of PPDU related to the operation of the present specification may be called by various names. For example, a PPDU related to the operation of the present specification may be used with various names such as a Small PPDU, a Short PPDU, a Low latency PPDU, a TX PPDU, an RX PPDU, a first/second PPDU, and the like. Hereinafter, the name Small PPDU is used for convenience of description, but the technical feature of the present specification is not limited to such a name of small PPDU.

A small PPDU related to the present specification may have a maximum duration set shorter than that of a conventional PPDU. Additionally or alternatively, the same aPPDUmaxtime parameter as that of a conventional PPDU is applied to the small PPDU, but the duration thereof may be set shorter than that of a conventional PPDU based on a parameter/field/subfield newly defined in the WIFI standard or a conventional parameter/field/subfield. Additionally or alternatively, the small PPDU may be a PPDU that does not include a Low latency PPDU. For example, the Low latency PPDU may be a PPDU that delivers Low latency traffic. The Low latency traffic may be identified based on at least one of QoS/AC (Access category)/TID (Traffic ID)/Delay/latency assigned to the corresponding traffic. Additionally or alternatively, the small PPDU may mean a set of a plurality of PPDUs for which an immediate ACK is not required and a delayed ACK is allowed. Additionally or alternatively, the small PPDU may mean a PPDU configured based on a preamble of a new structure proposed in the present specification (for example, a preamble in which a Legacy preamble is omitted as described below, or a preamble including only HE/EHT/UHR-LTF, or a preamble including only HE/EHT/UHR-STF and HE/EHT/UHR-LTF). The small PPDU of the present specification may include a preamble and a data field continuous to the preamble, and the data field may include a Physical Service Data Unit (PSDU). The small PPDU related to the present specification can be distinguished from a conventional PPDU based on at least one criterion/definition presented above. A conventional PPDU distinguished from a PPDU newly proposed in the present specification (for example, a small PPDU) may be called by various names. For example, various names such as long/large/legacy/HT/VHT/HE/EHT/UHR-PPDU may be used.

Additionally or alternatively, the small PPDU may be determined regardless of the length of the duration of the PPDU. For example, whether it is a small PPDU may be determined according to a physical version of the PPDU, or whether it is a small PPDU may be determined according to a type of the PPDU. In this case, information related to the type of the PPDU may be included in a U-SIG field and/or an EHT/UHR-SIG field of the PPDU, or the like.

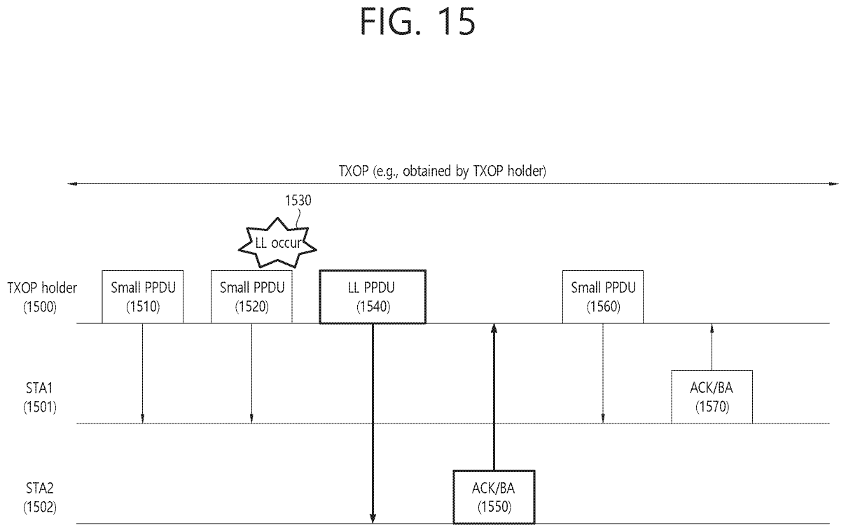

FIG. 15 is related to an operation performed in the device proposed in the present specification.

The illustrated transmission opportunity (TXOP) holder 1500 acquires a TXOP. A method of acquiring the TXOP may be based on a scheme of exchanging an RTS frame and a CTS frame based on a conventional WLAN standard, or transmitting a conventional CTS-to-self frame, or based on a conventional target wake time (TWT) setting. That is, the definition of the TXOP holder of the present specification may be the same as the conventional WLAN standard. In addition, in the example of FIG. 15, STAI 1501 may be a TXOP responder. That is, the definition of the TXOP responder of the present specification may be the same as the conventional WLAN standard. For example, the TXOP responder (e.g., STAI 1501) of the present specification may receive a response frame to a frame received from the TXOP holder during a frame exchange sequence, but may mean a STA that does not acquire the TXOP in a related processor. The TXOP holder may be a non-AP or an AP, and the TXOP responder may be an AP or a non-AP. The example of FIG. 15 is a case where the TXOP holder is an AP, and accordingly, the TXOP acquired in FIG. 15 may be expressed by various names such as DL-TXOP.

For example, small PPDUs may be transmitted continuously within one TXOP based on the example of FIG. 15. However, other PPDUs such as a Low Latency (LL) PPDU or a response thereto (e.g., ACK/Block ACK) may be transmitted and received between the small PPDUs. Specifically, as shown in FIG. 15, an LL PPDU 1540 and an ACK/BA 1550 for the corresponding LL PPDU may be transmitted and received between a plurality of small PPDUs 1510, 1520, and 1560. A signal called an LL PPDU in the present specification may include not only the LL PPDU but also a response (e.g., ACK/BA) to the LL PPDU.

The example of FIG. 15 is related to an example in which the LL PPDU is delivered to a third STA (that is, STA2 1520) that is not the TXOP responder or the TXOP holder through a downlink. That is, it is related to an example in which a transmitting STA (e.g., the TXOP holder 1500) preempts an on-going transmission within an already acquired TXOP and transmits the LL PPDU through the downlink. That is, the example of FIG. 15 is related to an example in which DL-preemption is applied in a situation where the DL-TXOP is acquired. When the LL PPDU 1540 is transmitted through the downlink based on the DL-preemption as in FIG. 15, since the STA2 1502 is not the TXOP responder, it may be difficult to transmit the response 1550 to the LL PPDU 1540. That is, in a process in which the TXOP holder 1500 acquires the DL-TXOP, various frames (e.g., RTS/CTS/CTS-to-self frame, intra-BSS frame/PPDU, etc.) may be delivered to the STA2 1502, and the STA2 1502 may set a NAV (e.g., intra-BSS NAV) based on the received frame. Due to this, the STA2 1502 may not be able to transmit the LL-PPDU and/or the response thereof during the already acquired TXOP. This technical feature can be solved by various technical features proposed in the present specification.

For example, if the TXOP holder 1500 transmits the LL PPDU at an arbitrary time point, the TXOP holder may transmit the LL PPDU after xIFS of a PPDU (e.g., small PPDU 1520) transmitted by the TXOP holder (e.g., after SIFS has elapsed). For example, in order for a STA that is not the TXOP holder (e.g., a STA that is neither the TXOP holder nor the TXOP responder) to transmit the LL PPDU (or the response thereof), permission from the TXOP holder may be required. Here, the permission from the TXOP holder may include signaling such as an indication that a frequency resource in the corresponding TXOP may be used and/or allocation of the frequency resource from the TXOP holder. For example, in order to allow LL PPDU transmission (including transmission of ACK/BA for the LL PPDU, for example) of a STA that is not the TXOP holder (e.g., STA2 1502 that is neither the TXOP holder nor the TXOP responder), whether to allow transmission and reception of the LL PPDU may be indicated after xIFS (e.g., after SIFS has elapsed) from the end of transmission of the corresponding Small PPDU in each Small PPDU.

For example, a U-SIG (and/or UHR-SIG) of at least one Small PPDU (or all small PPDUs) may include a Preemption flag (PF) subfield. For example, the PF subfield may have a length of 1 bit. For example, if a value of the PF subfield is a first value (e.g., 0), Preemption may not be allowed as in the conventional art. That is, a STA that is neither the TXOP holder nor the TXOP responder (e.g., STA2 1502) cannot transmit the LL PPDU (e.g., including ACK/BA for the LL PPDU) during the conventionally acquired TXOP. For example, if the value of the PF subfield is a second value (e.g., 0), Preemption may be allowed. For example, a STA that is neither the TXOP holder nor the TXOP responder (e.g., STA2 1502) can transmit the LL PPDU (e.g., including ACK/BA for the LL PPDU) during the conventionally acquired TXOP.

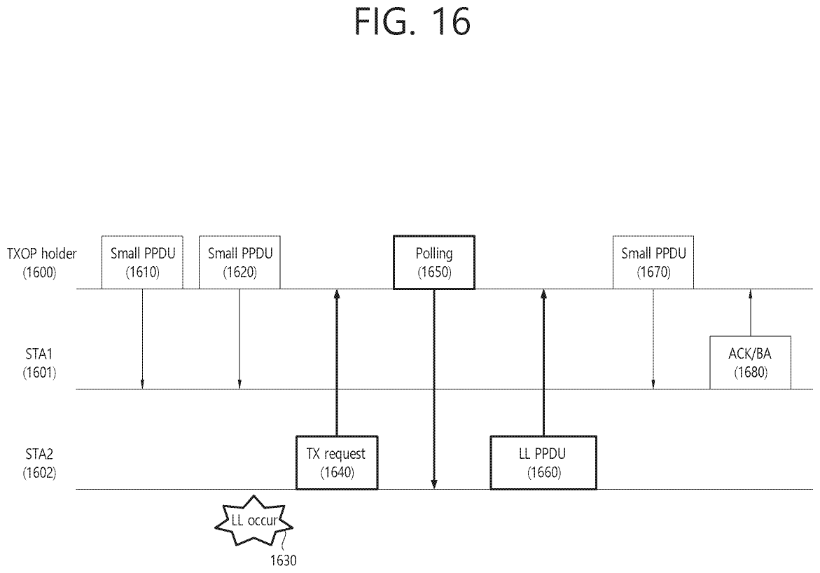

The above-described technical features are not limited to the example of FIG. 15. In addition, the example of FIG. 15 may be variously modified. The example of FIG. 15 is a situation in which the LL PPDU is delivered to a third STA other than the TX-holder/responder through the downlink within the DL-TXOP, that is, a situation in which the DL-TXOP and the DL-preemption are applied. The above-described technical features may be applied to a situation in which the DL-TXOP and UL-preemption are applied, may be applied to a situation in which UL-TXOP and DL-preemption are applied, and may be applied to a situation in which UL-TXOP and UL-preemption are applied. The situation in which the DL-TXOP and the UL-preemption are applied may be related to the example of FIG. 16. The situation in which the UL-TXOP and the DL-preemption are applied may be a situation in which a non-AP operates as the TXOP holder and an AP operates as the TXOP responder, and the AP transmits the LL PPDU to a third STA (that is, a STA other than the TXOP holder/responder) through the downlink. The situation in which the UL-TXOP and the UL-preemption are applied may be a situation in which the non-AP operates as the TXOP holder and the AP operates as the TXOP responder, and the third STA (that is, the STA other than the TXOP holder/responder) transmits the LL PPDU to the AP through the uplink.

FIG. 16 is related to another operation performed in the device proposed in the present specification. As described above, the example of FIG. 16 may be expressed as a situation in which the DL-TXOP and the UL-preemption are applied. In the example of FIG. 16, similarly to FIG. 15, at least one small PPDU and LL PPDU are exchanged in a situation where one DL-TXOP (not shown) is acquired by the TXOP holder 1600.

As illustrated, a third STA (e.g., STA2 1602) other than the TXOP holder/responder may receive a Small PPDU 1610 and/or 1620 with PF=1. For the STA2 1602, for example, a PF subfield of a U-SIG (and/or UHR-SIG) included in the Small PPDU 1610 and/or 1620 may have a preset value (e.g., “1”), and as in the example of FIG. 15, the value of the corresponding PF subfield may mean that DL-preemption is allowed. Accordingly, the STA2 1602 may transmit a Tx request frame 1640 after xIFS (e.g., SIFS) has elapsed from the Small PPDU 1620. The TX request frame 1640 is a frame used to request transmission of an LL PPDU (or a PPDU delivering traffic related to a specific condition or a specific QoS/AC (Access category)/TID (Traffic ID)/Delay/latency) of a third STA other than the TXOP holder/responder, and may be defined in various ways and may be called by various names. For example, the TX request frame 1640 may be transmitted to the TXOP holder.

As described above, the Tx request frame 1640 may be transmitted for permission of a STA having Data to transmit (or Data to transmit satisfying a specific condition). For example, the Tx request frame 1640 may mean a frame notifying the request to the TXOP holder 1600 that it wants to transmit Low latency traffic as in FIG. 16. As described above, the Tx request frame 1640 may be defined in various ways. For example, the Tx request frame 1640 may include part/all of a structure of a conventional CTS frame. That is, the TX request frame 1640 may be defined as a frame transmitted corresponding to a conventional RTS frame, and may be defined as a control frame identically to the conventional CTS frame. In addition, the TX request frame 1640 may include a frame control field of 2 octets, a duration field (2 octet length) following the field, and an RA (receiver address) field (6 octet length) following the field, and the RA field may be set to a value of a TA (transmitter address) field of the RTS frame. Additionally or alternatively, the Tx request frame 1640 may include a newly defined frame structure.

Additionally or alternatively, the Tx request frame 1640 may be transmitted based on a single frequency network (SFN) identically to the conventional CTS frame.

The TXOP holder 1600 may transmit an indication corresponding to the Tx request frame 1640. An example of the indication enables polling 1650 shown in FIG. 16. Additionally or alternatively, an example of the indication may be a trigger frame of the conventional WLAN standard. In addition, an example of the indication may include sequential transmission of an NDP feedback report poll (NFRP), an NDP feedback report (NFR), and a Trigger frame of the conventional WLAN standard.

When the indication is received from the TXOP holder 1600, the third STA (e.g., STA2 1602) other than the TXOP holder/responder may transmit an LL PPDU 1660.

An xIFS defined in the WLAN standard exists between each PPDU/frame mentioned in FIG. 15/16. For example, an example of xIFS may be SIFS/PIFS defined in the WLAN standard. The IFS between each PPDU/frame may be set to a different value depending on a situation and a PPDU type, etc. Also, in the example of FIG. 15/16, the TXOP holder is an AP, but as described above, the technical features of the present specification may also be applied to the UL-TXOP.

The technical features of the present specification are related to a technique of setting (or updating) a NAV in a STA (e.g., an AP and/or a non-AP). As described above, a specific STA (e.g., a third STA other than the TXOP holder/responder) may receive various frames (e.g., intra-BSS PPDU, RTS frame, CTS frame, CTS-to-self frame/PPDU) used in a process of acquiring the DL-TXOP and/or UL-TXOP, and may set (or update) the NAV (e.g., intra-BSS NAV). Such a STA may not be able to transmit a specific packet (e.g., the above-described LL-PPDU, or a PPDU delivering traffic related to a specific condition or a specific QoS/AC (Access category)/TID (Traffic ID)/Delay/latency) due to the set/updated NAV during the DL-TXOP and/or UL-TXOP. In order to solve the problem of not being able to transmit the above-described packet, a setting/updating technique of the NAV performed in the STA when preemption is allowed within the DL/UL-TXOP (e.g., when the LL-PPDU, etc. can be transmitted by the third STA) is proposed in the following example. In addition, a setting/updating technique of the NAV performed in a STA having received a small PPDU allowing the above-described preemption (e.g., a small PPDU including the PF subfield) is proposed in the following example.

Existing operations within a TXOP (e.g., UL/DL-TXOP) are as follows. That is, hereinafter, an operation of a STA within a TXOP in which preemption is not allowed, and/or an operation in a STA having received a small PPDU that does not include signaling allowing preemption are described.

### Technical Feature-1A

First, the existing operation of the TXOP holder may be as follows.

The TXOP holder may transmit a PPDU (without contention within the TXOP acquired by itself), and may indicate information related to a length (or duration) of the TXOP and a length (or duration) of the PPDU through the corresponding PPDU. For example, the length of the corresponding PPDU may be indicated through Length information (e.g., conventional 12-bit length information) of an L-SIG field included in the corresponding PPDU. For example, the length (or duration) of the remaining TXOP in the TXOP may be roughly indicated through a control bit of a U-SIG field included in the corresponding PPDU. (For example, if the remaining duration of the TXOP is less than 512 μs, the remaining duration may be indicated in units of 4 μs, and if the remaining duration of the TXOP is 512 μs or more, the remaining duration may be indicated in units of 64 μs). As an example, the remaining TXOP duration may be informed in units of us in a Duration field of a MAC header.

### Technical Feature-1B

Second, the existing operation of the TXOP responder may be as follows.

The TXOP responder may receive and decode the PPDU, and if its STA-ID (e.g., included in EHT/UHR-SIG) and/or Address (e.g., included in MAC header) are included, it may receive data allocated to itself. After the corresponding PPDU ends, it may prepare for PPDU reception again. Here, the reception preparation may be Energy detection, Preamble detection, and decoding, etc.

### Technical Feature-1C

Third, the existing operation of the third STA other than the TXOP holder/responder may be as follows.

Third STAs (e.g., BSS/OBSS STAs) other than the TXOP holder and responder perform NAV setting as much as the corresponding TXOP. As an example, transmission is not performed and only PPDU reception may be performed during a time corresponding to the corresponding NAV. The NAV may be an intra-BSS NAV, or a basic NAV.

Hereinafter, a TXOP/small PPDU in which preemption is allowed is described.

Hereinafter, operations in the TXOP holder, the TXOP responder, and the third STA other than the TXOP holder/responder are described individually.

### Technical Feature-2A

Hereinafter, technical features of the TXOP holder within a TXOP in which preemption is allowed (or for a small PPDU in which preemption is allowed) are described.

The TXOP holder performs the same operation as the operation described in “Technical Feature-1A” described above. However, after the Preemption-allowed Small PPDU is transmitted and received, the PPDU of the TXOP holder may be transmitted, but the TXOP holder must recognize that the above-described Tx request frame may be received from STAs.

As an example, considering that the Tx request frame may be received from STAs after SIFS has elapsed from the Small PPDU, it is possible to transmit the PPDU of the TXOP holder after PIFS has elapsed if the corresponding frame is not received while preparing for reception.

### Technical Feature-2B Hereinafter, technical features in the TXOP responder within a TXOP in which preemption is allowed (or for a small PPDU in which preemption is allowed) are described.

The TXOP responder performs the same operation as the operation described in “Technical Feature-1B” described above. However, after the Preemption-allowed Small PPDU, not only the reception of the next PPDU, but also the above-described Tx request frame may be transmitted to request transmission of the PPDU of the TXOP responder. As an example, the above-described Tx request frame may be transmitted after SIFS has elapsed from the Small PPDU, and if there is no Tx request frame to transmit, reception of the PPDU may be prepared after PIFS has elapsed.

### Technical Feature-2C

Hereinafter, technical features in the third STA (e.g., BSS STA and/or OBSS STA) other than the TXOP holder/responder within a TXOP in which preemption is allowed (or for a small PPDU in which preemption is allowed) are described.

Hereinafter, a number of examples of ignoring the NAV in the STA in various ways are proposed.

According to a first example of ignoring the NAV, the BSS STA other than the TXOP holder/responder may not perform NAV setting/update after receiving the Preemption-allowed Small PPDU (e.g., a small PPDU including the U-SIG including the PF subfield having a preset value) (or within the TXOP in which preemption is allowed). A method of not performing NAV setting/update may be implemented in various ways. For example, even if an existing set/updated NAV (e.g., intra-BSS NAV) exists in the STA, if the Preemption-allowed Small PPDU is received, the corresponding NAV may be ignored (or may not be considered). For example, if the NAV is not set/updated, the corresponding STA (that is, the BSS STA other than the TXOP holder/responder) may ignore the corresponding NAV because there is no need to consider the NAV. As a result, the corresponding STA may ignore the NAV and transmit a specific PPDU (e.g., LL PPDU, TX request frame for transmission of LL PPDU, ACK/BA for LL PPDU, PPDU delivering traffic related to a specific condition or a specific QoS/AC (Access category)/TID (Traffic ID)/Delay/latency, etc.) to the TXOP holder within the TXOP acquired by the TXOP holder (e.g., within the DL/UL TXOP in which Preemption is allowed).

According to a second example of ignoring the NAV, the BSS STA other than the TXOP holder/responder may perform NAV setting during a duration indicated by the Small PPDU (e.g., duration information included in an L-SIG field in the small PPDU or duration information indicated by an A-MPDU in the small PPDU), and then may release the NAV after the corresponding NAV ends. In other words, the BSS STA other than the TXOP holder/responder may set the NAV based on the small PPDU, rather than setting the NAV based on a signal (e.g., RTS/CTS/CTS-to-self frame, intra-BSS frame/PPDU, etc.) received in a process in which the TXOP is acquired. Specifically, the BSS STA other than the TXOP holder/responder may ignore the corresponding NAV even if the NAV is set based on the signal (e.g., RTS/CTS/CTS-to-self frame, intra-BSS frame/PPDU, etc.) received in the process in which the TXOP is acquired, and set the NAV based on the small PPDU. When the NAV is set based on the signal (e.g., RTS/CTS/CTS-to-self frame, intra-BSS frame/PPDU, etc.) received in the process in which the TXOP is acquired, since the duration of the NAV may become very long, a problem may occur in which the BSS STA other than the TXOP holder/responder cannot transmit the LL PPDU, etc. for a long period of time. In summary, the BSS STA other than the TXOP holder/responder may set the NAV based on the duration indicated by the Small PPDU (e.g., duration information included in the L-SIG field in the small PPDU or duration information indicated by the A-MPDU in the small PPDU) after receiving the Preemption-allowed Small PPDU (e.g., the small PPDU including the U-SIG including the PF subfield having a preset value) (or within the TXOP in which preemption is allowed). In this case, the BSS STA other than the TXOP holder/responder may ignore (or may not consider) the NAV set based on the signal (e.g., RTS/CTS/CTS-to-self frame, intra-BSS frame/PPDU, etc.) received in the process in which the TXOP is acquired.

Additionally or alternatively, the various operations of ignoring the NAV described above may not be applied to a STA that cannot determine whether Preemption is allowed and/or a STA that cannot recognize a Type of the Small PPDU (e.g., an EHT STA and a STA of a previous version thereof, or a UHR STA that does not allow Preemption, etc.).

According to a third example of ignoring the NAV, the various operations of ignoring the NAV described above may be applied only to a STA having a PPDU to transmit among BSS STAs other than the TXOP holder/responder. That is, the operation of ignoring the NAV may not be applied to all BSS STAs other than the TXOP holder/responder. For example, only a STA that transmits traffic/PPDU meeting a specific condition (e.g., LL PPDU, TX request frame for transmission of LL PPDU, ACK/BA for LL PPDU, PPDU delivering traffic related to a specific condition or a specific QoS/AC (Access category)/TID (Traffic ID)/Delay/latency, etc.) among BSS STAs other than the TXOP holder/responder may ignore the NAV. More specifically, the BSS STA other than the TXOP holder/responder may determine whether to ignore an existing set/updated NAV. That is, the BSS STA other than the TXOP holder/responder may i) set a NAV (e.g., intra-BSS NAV) based on a signal (e.g., RTS/CTS/CTS-to-self frame, intra-BSS frame/PPDU, etc.) received in a process in which the TXOP is acquired, and ii) ignore (or not consider) the corresponding NAV if a specific condition is satisfied. The “specific condition” is determined based on a) whether the corresponding BSS STA is not the TXOP holder/responder; and b) whether the corresponding BSS STA transmits traffic/PPDU meeting a specific condition (e.g., LL PPDU, TX request frame for transmission of LL PPDU, ACK/BA for LL PPDU, PPDU delivering traffic related to a specific condition or a specific QoS/AC (access category)/TID (Traffic ID)/Delay/latency, etc.). That is, only when the corresponding BSS STA is not the TXOP holder/responder and the corresponding BSS STA transmits traffic/PPDU meeting a specific condition, the corresponding NAV can be ignored (or not considered). In other cases, the NAV may not be ignored.

As described above, specific examples of ignoring the NAV may be implemented in various ways. For example, even if the NAV is set according to a conventional technique (e.g., intra-BSS NAV is set/updated according to a conventional technique based on RTS/CTS/CTS-to-self frame, intra-BSS frame/PPDU, etc.), the corresponding NAV may be ignored when transmitting the Tx request frame for the LL PPDU. As such, even if the NAV is set/updated, transmitting without considering the corresponding NAV may correspond to ignoring the NAV.

Technical Feature-2D.

Additionally or alternatively, as described above, the technical feature of ignoring (or not-considering) the NAV may be used only in a specific case. For example, in a situation where the TXOP holder is a Non-AP STA and the TXOP responder is an AP, and a PPDU to be transmitted by a BSS STA not corresponding to the TXOP holder/responder exists, the above-described technical feature (that is, the technical feature of ignoring the NAV) may not be applied. That is, in the situation where the TXOP holder is the Non-AP STA and the TXOP responder is the AP, and the PPDU to be transmitted by the BSS STA not corresponding to the TXOP holder/responder exists, transmission of the above-described Tx request frame may be restricted. In order to implement such an operation, ‘when the Small PPDU consists of a UL PPDU (that is, when a DL/UL subfield, which is a 1-bit subfield of the U-SIG field included in the small PPDU, indicates ‘UL’), the Tx request frame of Non-AP STAs may not be allowed regardless of the PF subfield value included in the corresponding U-SIG field.

### Technical Feature-2E

The above-described “Technical Feature-2C” and “Technical Feature-2D” may be applied to all STAs other than the TXOP holder/responder, or may be applied only to BSS STAs other than the TXOP holder/responder. For example, when the above-described “Technical Feature-2C” and “Technical Feature-2D” are not applied to an OBSS STA, even if the OBSS STA receives the Preemption-allowed Inter-BSS Small PPDU, it may set a basic NAV as in the conventional art (that is, set a NAV for the inter-BSS based on the received small PPDU) and not transmit the above-described Tx request frame. The basic NAV set as above may be ignored if spatial reuse (SR) is considered.

Additionally or alternatively, the OBSS STA may not transmit the above-described Tx request frame to the TXOP holder, but may perform transmission and reception with STAs (including AP) in the corresponding OBSS using a Spatial reuse technique. For example, by increasing an OBSS PD (Power Detection) level in the corresponding OBSS, if an interference level of the corresponding STA (including AP) is equal to or less than the OBSS PD level, a packet/PPDU may be transmitted within the OBSS. The OBSS PD level may be set in advance between the AP and STAs in the OBSS, and may be shared (negotiation or announcement) with the BSS AP in advance. The above-described SR technique is further described as follows, For example, the OBSS STA may determine whether a surrounding wireless channel is Busy or idle based on the OBSS PD level. The OBSS PD level related to the SR technique may be set to have a higher threshold value than a typical PD level (e.g., a threshold value increased by 10 dBm compared to the conventional one is set). Through this, the OBSS STA may determine a wireless channel, which would have been determined as busy if it were a conventional PD level, as idle. The OBSS STA applying the OBSS PD level as above may transmit a PPDU within the OBSS based on transmission power set based on the threshold value of the increased PD level. For example, according to the above-described SR technique, if the threshold value of the PD level increases by 10 dBm, a maximum value of transmission power applied to the corresponding OBSS STA may decrease by 10 dBm. According to this scheme, the OBSS STA can transmit the PPDU based on the increased PD Level (that is, OBSS PD level) and the decreased maximum value of transmission power within the OBSS even while the basic NAV is set (that is, while the BSS TXOP is set).

### Technical Feature-3

A method of allowing Preemption in the present specification may be implemented in various ways. That is, a method in which a STA other than the TXOP holder/responder can transmit traffic/PPDU meeting a specific condition (e.g., LL PPDU, TX request frame for transmission of LL PPDU, ACK/BA for LL PPDU, PPDU delivering traffic related to a specific condition or a specific QoS/AC (access category)/TID (Traffic ID)/Delay/latency, etc.) to the TXOP holder during the conventionally acquired TXOP may be implemented in various ways.

For example, at least one technical feature described in “Technical Feature-2A” to “Technical Feature-2E” described above may be used.

Additionally or alternatively, Preemption may be allowed according to the following method.

For example, the AP/STA (e.g., TXOP holder) of the present specification may set the TXOP shortly multiple times in order to allow Preemption. As an example, the TXOP holder may set a short TXOP while transmitting a conventional RTS frame or PPDU (e.g., Small PPDU). That is, a value of duration information included in the corresponding RTS frame or PPDU may be set shortly. If xIFS (e.g., SIFS) elapses after the corresponding RTS frame or PPDU is transmitted, the TXOP holder may immediately transmit the RTS frame or PPDU (e.g., Small PPDU) again (without needing to perform contention for channel access). The value of duration information of the RTS/PPDU transmitted again is set shortly. The TXOP holder can acquire a plurality of continuous short TXOPs by performing the above operation as many times as necessary, and this can consequently achieve the same effect as setting a long TXOP. At this time, in order to prevent a length of channel occupation from becoming excessively long, a maximum length of a sum of the plurality of continuous short TXOPs that can be acquired by the TXOP holder may be limited. The maximum length of the sum of the plurality of short TXOPs may be set based on a maximum length of one existing TXOP.

For example, an example of a specific method of setting a short TXOP is as follows. For example, when acquiring/setting a TXOP based on exchange of an RTS frame and a CTS frame, the TXOP holder may set the length of the TXOP shortly by setting a Duration/ID field of a MAC header of the RTS frame to ‘0’. Additionally or alternatively, the TXOP holder may set a value of the Duration/ID field of the MAC header of the RTS frame based on a start or end of a Small PPDU transmitted and received after the exchange of the RTS/CTS frame. That is, the TXOP holder may set the value of the Duration/ID field of the MAC header of the RTS frame shortly so as to cover only up to the Small PPDU (and ACK/BA for the small PPDU) transmitted and received after the exchange of the RTS/CTS frame. Additionally or alternatively, when acquiring/setting the TXOP based on the Small PPDU, the TXOP holder may set a Duration/ID field of an A-MPDU configuring the corresponding PPDU to ‘0’. Additionally or alternatively, when acquiring/setting the TXOP based on the Small PPDU, the TXOP holder may set the Duration/ID field of the A-MPDU configuring the corresponding PPDU shortly so as to cover only up to the end of the corresponding PPDU.

When the TXOP is set relatively shortly according to the above technique, STAs requiring Preemption (e.g., STAs transmitting specific traffic among BSS/OBSS STAs other than the TXOP holder/responder) may transmit the above-described Tx request frame while the NAV set/updated by themselves is released after the short TXOP ends. That is, the above-described Tx request frame can be transmitted in a timely manner without performing the technical features of ignoring the NAV (e.g., the features described in the above-described “Technical Feature-2C” to “Technical Feature-2E”). However, in this case, other STAs may also attempt to transmit their own Data as their NAVs are released after the short TXOP ends, so a collision may occur between a STA requiring preemption and a STA that does not. As an example of a method for minimizing such a collision, STAs that do not require Preemption among STAs capable of identifying Preemption information (that is, STAs that do not transmit specific traffic such as LL PPDU among BSS/OBSS STAs other than the TXOP holder/responder) may be set not to attempt their own PPDU transmission (e.g., uplink PPDU transmission) during a preset period even if their NAV is released.

The above-described technical features may be described based on the following procedure flowchart.

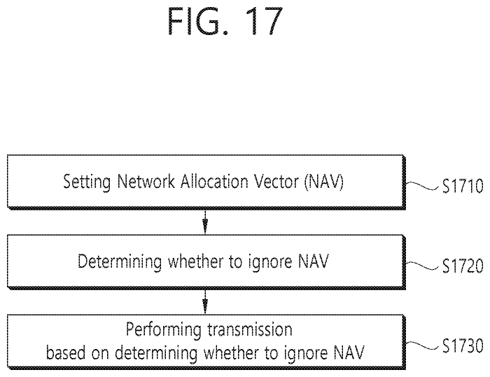

FIG. 17 is an example of a procedure flowchart of the present specification.

Each step of FIG. 17 may be performed by various STAs (AP-STA, Relay STA, non-AP STA) of the WLAN system. A STA performing each step of FIG. 17 may be a BSS STA (and/or OBSS STA) other than the TXOP holder/responder. Additionally or alternatively, the STA performing each step of FIG. 17 may be a STA transmitting traffic/PPDU meeting a specific condition (e.g., LL PPDU, TX request frame for transmission of LL PPDU, ACK/BA for LL PPDU, PPDU delivering traffic related to a specific condition or a specific QoS/AC (access category)/TID (Traffic ID)/Delay/latency, etc.) to the TXOP holder among BSS STAs (and/or OBSS STAs) other than the TXOP holder/responder.

As shown in step S1710, the STA may set a network allocation vector (NAV). The expression of setting the NAV may be replaced with the expression of updating the NAV. The STA may acquire various signals (e.g., RTS/CTS/CTS-to-self frame, intra-BSS frame/PPDU, etc.) transmitted and received in a process in which the TXOP holder acquires the DL/UL-TXOP, and may set the NAV based on the acquired signals. For example, the NAV set in step S1710 may correspond to a length of one TXOP acquired by the TXOP holder.

In step S1710, the STA may set the NAV based on an intra-BSS PPDU. The intra-BSS PPDU may include an RTS/CTS/CTS-to-self frame related to TXOP acquisition. For example, the intra-BSS PPDU may include a PPDU transmitted by the TXOP holder/responder. For example, the intra-BSS PPDU includes a common control field (e.g., U-SIG field), and the common control field may include, for example, a BSS color field of 6 bits. The STA may identify whether the received PPDU is an intra-BSS PPDU or an inter-BSS PPDU based on the BSS color field. When the received PPDU is the intra-BSS PPDU, the STA may set/update the NAV (e.g., intra-BSS NAV) based on the received PPDU. Specifically, the STA may set/update the NAV (e.g., intra-BSS NAV) based on a TXOP field (e.g., 7-bit information) included in the common control field (e.g., U-SIG field) of the received intra-BSS PPDU, and/or based on duration/ID information included in a MAC header in the intra-BSS PPDU.

As shown in step S1720, the STA determines whether to ignore the set NAV. For example, the STA may determine whether to ignore the NAV set/updated based on step S1710 within one TXOP acquired by the TXOP holder. The operation of ignoring the set NAV may be implemented in various ways. Accordingly, the expression of ignoring the set NAV may be replaced with another expression. For example, ignoring the set NAV may mean not considering the set NAV, mean changing the set NAV value to a preset value (e.g., ‘0’), or mean releasing the set NAV value.

The step of determining whether to ignore the NAV according to step S1720 may be based on the contents of the above-described “Technical Feature-2C”, “Technical Feature-2D”, and “Technical Feature-2E”.

For example, as described in “Technical Feature-2C”, the BSS STA other than the TXOP holder/responder may not perform NAV setting/update after receiving the Preemption-allowed Small PPDU (e.g., the small PPDU including the U-SIG including the PF subfield having a preset value) (or within the TXOP in which preemption is allowed). In other words, the STA may a) determine whether it is a BSS STA other than the TXOP holder/responder, and b) determine whether it has received the Preemption-allowed Small PPDU. That is, step S1720 may include a) determining whether it is a BSS STA other than the TXOP holder/responder, and b) determining whether it has received the Preemption-allowed Small PPDU. For example, if the condition/determination of “a)” and the condition/determination of “b)” described above are not satisfied, the STA cannot ignore the existing set NAV.

Additionally or alternatively, as described in “Technical Feature-2C”, the BSS STA other than the TXOP holder/responder may ignore the corresponding NAV even if the NAV is set based on a signal (e.g., RTS/CTS/CTS-to-self frame, intra-BSS frame/PPDU, etc.) received in a process in which the TXOP is acquired, and set the NAV based on duration indicated by the Small PPDU (e.g., duration information included in the L-SIG field in the small PPDU or duration information indicated by the A-MPDU in the small PPDU). In other words, the STA may a) determine whether it is a BSS STA other than the TXOP holder/responder, and b) determine whether duration indicating the NAV is included in the Small PPDU (e.g., duration information included in the L-SIG field in the small PPDU or duration information indicated by the A-MPDU in the small PPDU). That is, step S1720 may include a) determining whether it is a BSS STA other than the TXOP holder/responder, and b) determining whether it has received the Preemption-allowed Small PPDU and duration indicating the NAV is included in the corresponding Small PPDU. For example, if the condition/determination of “a)” and the condition/determination of “b)” described above are not satisfied, the STA cannot ignore the existing set NAV.

Additionally or alternatively, as described in “Technical Feature-2C”, only a STA that transmits traffic/PPDU meeting a specific condition (e.g., LL PPDU, TX request frame for transmission of LL PPDU, ACK/BA for LL PPDU, PPDU delivering traffic related to a specific condition or a specific QoS/AC (Access category)/TID (Traffic ID)/Delay/latency, etc.) among BSS STAs other than the TXOP holder/responder may ignore the NAV. In other words, the STA may a) determine whether it is a BSS STA other than the TXOP holder/responder, b) determine whether it has received the Preemption-allowed Small PPDU, and c) determine whether it transmits traffic/PPDU meeting a specific condition. That is, step S1720 may include a) determining whether it is a BSS STA other than the TXOP holder/responder, b) determining whether it has received the Preemption-allowed Small PPDU, and c) determining whether it transmits traffic/PPDU meeting a specific condition. For example, if the condition/determination of “a)”, the condition/determination of “b)”, and the “condition/determination of c)” described above are not satisfied, the STA cannot ignore the existing set NAV. All of the above conditions/determinations are not essential components, and some conditions/determinations may be omitted. For example, since a method of signaling whether preemption is allowed can be implemented in various ways, the above-described determination/determination of “b)” may be omitted.

As shown in step S1730, a transmission operation is performed based on whether to ignore the NAV. That is, the STA that has determined to ignore the NAV in step S1720 may ignore the existing set NAV and transmit traffic/PPDU (e.g., LL PPDU, TX request frame for transmission of LL PPDU, ACK/BA for LL PPDU, PPDU delivering traffic related to a specific condition or a specific QoS/AC (access category)/TID (Traffic ID)/Delay/latency, etc.) (to the TXOP holder). For example, the STA that has determined to ignore the NAV may perform an operation of ignoring the existing set NAV and transmitting the above-described TX request frame, transmitting the LL PPDU, or transmitting ACK/BA for the LL PPDU, etc. during the TXOP acquired by the TXOP holder. That is, in other words, the STA may ignore the existing set NAV and transmit a request signal related to a low latency packet (that is, the above-described TX request frame) during the TXOP acquired by the TXOP holder. The step of transmitting the above-described TX request frame is not an essential step. For example, if it is not determined to ignore the NAV by step S1720, the step of transmitting the TX request frame may be omitted.

The STA that has determined not to ignore the NAV in step S1720 performs a subsequent operation according to the existing set NAV (S1730). That is, since the subsequent operation is performed according to the NAV set in step S1710, transmission is not started until the corresponding NAV is released. In other words, only a reception operation may be performed without performing a transmission operation during the TXOP acquired by the TXOP holder.

The technical features of the present specification (e.g., technical features described in at least one of FIGS. 15 to 17) may be performed by various devices. The device of the present specification may be the device described in FIG. 1/FIG. 14. The device of the present specification may include at least one processor; and at least one computer memory operably connectable to the at least one processor and storing instructions performing operations based on being executed by the at least one processor.

For example, the processor may be the processor described in FIG. 1 and/or FIG. 14. That is, as described above, the processor of the present specification may include at least one of a DSP (digital signal processor), a CPU (central processing unit), a GPU (graphics processing unit), and a Modem (modulator and demodulator). The processor includes specialized circuits such as an FPGA, an ASIC, a signal processing device, and other devices as well as computers having various architectures such as a single/multiple processor architecture and a sequential (Von Neumann)/parallel architecture. For example, the processor of the present specification may be a SNAPDRAGON® series processor manufactured by Qualcomm®, an EXYNOS® series processor manufactured by Samsung®, an A series processor manufactured by Apple®, a HELIO® series processor manufactured by MediaTek®, an ATOM® series processor manufactured by INTEL®, or a processor enhancing them.

For example, the instructions may mean computer program instructions executed by the at least one processor. The (computer program) instructions provide logic and/or a routine allowing the technical features of the present specification (technical features described in at least one of FIGS. 15 to 17) to be performed by the processor. The at least one processor may load and execute the computer program by reading the at least one memory.

The computer program(s) defined by the instructions may arrive at the device (e.g., STA) of the present specification through an appropriate delivery mechanism. The delivery mechanism may be, for example, a computer-readable storage medium, a computer program product, a memory device, a recording medium such as a CD-ROM or DVD, or a product tangibly embodying the computer program. The delivery mechanism may be a signal configured to reliably transmit the computer program via a wireless or electrical connection.

The (computer program) instructions may include software or firmware for a programmable processor (e.g., programmable content of a hardware device whether instructions for a processor, or configuration settings for a fixed-function device, gate array or programmable logic device, etc.).

For example, the memory may be the memory described in FIG. 1 and/or FIG. 14. That is, as described above, the memory of the present specification may store control information related to the operation of the STA of the present specification or information related to a signal (e.g., a PPDU including a management/control/data frame) transmitted and received by the corresponding STA.

The technical features of the present specification may be implemented as at least one computer readable medium (CRM). The CRM includes instructions based on being executed by the above-described at least one processor. The instructions stored in the CRM may be the above-described computer program instructions.

The device of the present specification may further include a transceiver. The transceiver may be operably connectable to the memory/processor, etc. The transceiver may be the transceiver shown in FIG. 1 and/or FIG. 14.

The technical features of the disclosure described above are applicable to a variety of applications or business models. For example, the technical features described above may be applied for wireless communication in devices that support artificial intelligence (AI).

Artificial intelligence refers to a field of study on artificial intelligence or methodologies for creating artificial intelligence, and machine learning refers to a field of study on methodologies for defining and solving various issues in the area of artificial intelligence.

Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning, Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

1. A method performed in a Wireless Local Area Network (WLAN) system, the method comprising:
setting, by a STA, a network allocation vector (NAV) based on an intra basic service set (BSS) Physical Protocol Data Unit (PPDU);
determining whether the STA considers the NAV based on whether the STA is one of a transmission opportunity (TXOP) holder and a TXOP responder and based on a packet to be transmitted by the STA,
wherein, when the STA is not the transmission opportunity (TXOP) holder and is not the TXOP responder and the packet to be transmitted is related to a low latency packet, the STA does not consider the NAV; and
transmitting, by the STA, a request signal related to the packet.

2. The method of claim 1, wherein the intra PPDU is received from an access point (AP) within a Basic Service Set (BSS) to which the STA belongs, and the NAV is an intra-BSS NAV.

3. The method of claim 1, wherein the STA includes a basic NAV, and the basic NAV is set by an inter BSS PPDU.

4. The method of claim 1, wherein the request signal related to the packet is transmitted to the transmission opportunity (TXOP) holder.

5. The method of claim 1, wherein the STA transmits the request signal related to the packet during a TXOP acquired by the TXOP holder.

6. The method of claim 1, wherein the STA determines a subfield within the received PPDU has preset value, wherein the subfield is a flag field included in a universal signal (U-SIG) field of the received PPDU, and when the flag field has the preset value, the STA does not consider the NAV.

7. The method of claim 1, wherein the intra BSS PPDU includes a Ready To Transmit (RTS) frame received from the TXOP holder or a Clear To Transmit (CTS) frame received from the TXOP responder.

8. station in a wireless local area network (LAN) system, comprising:
at least one processor; and
at least one computer memory operatively connected to the at least one processor and storing instructions that, based on being executed by the at least one processor, perform operations comprising:
setting, by a STA, a network allocation vector (NAV) based on an intra basic service set (BSS) Physical Protocol Data Unit (PPDU);
determining whether the STA considers the NAV based on whether the STA is one of a transmission opportunity (TXOP) holder and a TXOP responder and based on a packet to be transmitted by the STA,
wherein, when the STA is not the transmission opportunity (TXOP) holder and is not the TXOP responder and the packet to be transmitted is related to a low latency packet, the STA does not consider the NAV; and
transmitting, by the STA, a request signal related to the packet.

9. STA of claim 8, wherein the intra PPDU is received from an access point (AP) within a Basic Service Set (BSS) to which the STA belongs, and the NAV is an intra-BSS NAV.

10. The STA of claim 8, wherein the STA includes a basic NAV, and the basic NAV is set by an inter BSS PPDU.

11. The STA of claim 8, wherein the request signal related to the packet is transmitted to the transmission opportunity (TXOP) holder.

12. The STA of claim 8, wherein the STA transmits the request signal related to the packet during a TXOP acquired by the TXOP holder.

13. The STA of claim 8, wherein the STA determines a subfield within the received PPDU has preset value, wherein the subfield is a flag field included in a universal signal (U-SIG) field of the received PPDU, and when the flag field has the preset value, the STA does not consider the NAV.

14. The STA of claim 8, wherein the intra BSS PPDU includes a Ready To Transmit (RTS) frame received from the TXOP holder or a Clear To Transmit (CTS) frame received from the TXOP responder.

15. At least one computer readable medium (CRM) storing instructions that, based on being executed by at least one processor in a wireless local area network (LAN) system,, perform operations comprising:
setting, by a STA, a network allocation vector (NAV) based on an intra basic service set (BSS) Physical Protocol Data Unit (PPDU);
determining whether the STA considers the NAV based on whether the STA is one of a transmission opportunity (TXOP) holder and a TXOP responder and based on a packet to be transmitted by the STA,
wherein, when the STA is not the transmission opportunity (TXOP) holder and is not the TXOP responder and the packet to be transmitted is related to a low latency packet, the STA does not consider the NAV; and
transmitting, by the STA, a request signal related to the packet.

16. (canceled)
